(19) United States
(12) Patent Application Publication
(10) Pub. No.: US 2012/0096029 A1
(43) Pub. Date: Apr. 19, 2012

(54) INFORMATION ANALYSIS APPARATUS, INFORMATION ANALYSIS METHOD, AND COMPUTER READABLE STORAGE MEDIUM

(75) Inventors: Akihiro Tamura, Tokyo (JP); Kai Ishikawa, Tokyo (JP); Shinichi Ando, Tokyo (JP)

(73) Assignee: NEC CORPORATION, Tokyo (JP)

(21) Appl. No.: 13/380,735

(22) PCT Filed: May 28, 2010
(86) PCT No.: PCT/JP2010/003609

§ 371 Date: Dec. 23, 2011

(30) Foreign Application Priority Data
Jun. 26, 2009 (JP) 2009-152758

(51) Int. Cl. G06F 17/30

(52) U.S. Cl. 707/772; 707/E17.008; 707/E17.058; 707/E17.069

(57) ABSTRACT

An information analysis device (30) comprises a relevant portion identification unit (31) that compares analyzed target text with topic-related text that is written about the same event as the analyzed target text and includes information related to a specific topic, and that specifies a portion of the analyzed target text related to the topic-related text; a potential topic word extraction unit (32) that extracts a word of the specific portion; and a statistical model generation unit (33) that generates a statistical model that estimates a degree of appearance of a word on a specific topic of the analyzed target text. The statistical model generation unit (33) generates a statistical model such that degrees of appearance in a specific topic of the topic-related text word and of the extracted word are higher than those of other words.

### TECHNICAL FIELD

The present invention relates to an information analysis apparatus, information analysis method, and a computer-readable storage medium used to generate a statistical model for estimating the extent of occurrence of words in a specific topic using two kinds of text describing identical events.

### BACKGROUND ART

There have been developed in recent years various text analysis methods used for analyzing large amounts of text. In one analytical method among the above, the extent to which words contained in a text to be analyzed occur in a topic to be identified is estimated and analysis is performed based on the results (see Non-patent Document 1 and Non-patent Document 2).

For example, a text analysis method used for newspaper data has been disclosed in Non-patent Document 1. The text analysis method disclosed in Non-patent Document 1 estimates the extent to which words contained in news articles (text) to be analyzed occur in topics and identifies the topics of that news articles.

In addition, a text analysis method based on topic segmentation has been disclosed in Non-patent Document 2. In the text analysis method disclosed in Non-patent Document 2, the extent of occurrence of words in topics is modeled and the resultant model is used to perform topic segmentation by dividing a text containing multiple topics into chunks featuring a single topic.

Both in Non-patent Document 1 and Non-patent Document 2, the extent to which words contained in the text to be analyzed occur in the topic to be identified is determined statistically with the help of training data based on the frequency of occurrence of said words in said topic and other indices. In this application, texts that describe the topic to be identified and texts that describe topics other than the topic to be identified are suggested as training data. Speaking specifically, texts that have underlying events in common with the text to be analyzed but are created through a process different from the text to be analyzed with respect to the topic to be identified are suggested as training data.

For example, let us suppose that a text has been obtained as a result of speech recognition performed on telephone call speech at a Call Center. The events underlying this text are telephone calls made to the Call Center. In addition, in many cases, operators at the Call Center record information obtained from the telephone calls in the form of a Help Desk memo. Accordingly, if a text obtained via speech recognition is subject to analysis, the text of the parts describing the topic to be identified (e.g. “Computer PC Malfunction Status”, etc.) in such a Help Desk memo can be regarded as training data.

In addition, let us assume a case where a news program script containing numerous topics or a text obtained as a result of speech recognition performed on the audio of the program are subject to analysis. In such a case, newspaper articles from the same date as the news program are created based on events etc. that are identical to those covered in the news program. Accordingly, in such a case, the news articles that cover the topic to be identified (for example, “economy”, etc.) among said newspaper articles can be regarded as training data.

Thus, the text analysis methods disclosed in Non-patent Document 1 or Non-patent Document 2 are applicable when there is text to be analyzed and text used as training data. This allows for modeling the extent, to which words contained in the text data to be analyzed occur in the topic to be identified and makes statistical model training possible.

### CITATION LIST

### Patent Document

### Non-Patent Document 1:

Kentaro Yokoi, Tatsuya Kawahara, Shuji Doshita, “Topic Identification of News Speech Using Word Co-Occurrence Statistics”, IEICE Technical Report (SP, speech), Vol. 96, No. 449, 1997, pp. 71-78.

### Non-Patent Document 2:

Rui Amaral and Isabel Trancoso, “Topic Detection in Read Documents”, in Proceedings of 4th European Conference on Research and Advanced Technology for Digital Libraries, 2000, pp. 315-318.

### DISCLOSURE OF THE INVENTION

### Problem to be Solved by the Invention

Incidentally, generally speaking, the greater the difference between the words and the trends of the words used is in the text to be analyzed and the text used as training data, the more unsuitable the statistical model generated from said training data becomes for the analysis of the text to be analyzed. In addition, it is believed that the words used in the text to be analyzed and text used as training data are often different. This leads to the problem of low analytical accuracy in the text analysis methods disclosed in the above-described Non-patent Document 1 and Non-patent Document 2.

For example, let us consider a situation, in which a text to be analyzed is obtained as a result of speech recognition performed on telephone call speech at a Call Center and training data is made up of text related to the topic to be identified that is contained in a Help Desk memo created based on a telephone call made to the Call Center. In such a case, the Help Desk memo is created by an operator and, in most cases, the information from the telephone call is described in the Help Desk memo in abridged form.

For this reason, it is believed that the text of the Help Desk memo is often different from the words used in the telephone call. In addition, it is also believed that, in many cases, not all of said topic-related information from the telephone call is included in the text of the Help Desk memo. Furthermore, it is believed that quite often there are cases, in which topic-related information missing from the telephone call is supplemented in the Help Desk memo based on the judgment of the operator.

Thus, in many cases, the words used in the text to be analyzed and in the text used as training data are different and, furthermore, the trends of the words used are different as well. In such cases, the extent to which words contained in the text to be analyzed occur in the topic to be identified is not adequately estimated during text analysis based on a statistical model created from the training data, which leads, as described above, to the problem of low analytical accuracy.

It is an object of the present invention to eliminate the above-described problems and provide an information analysis apparatus, an information analysis method, and a computer-readable storage medium capable of precluding degradation in the accuracy of estimation in a statistical model that estimates the extent of occurrence of words in a text to be analyzed even when there are differences between the words used in the text to be analyzed and in the text describing a specific topic that is used as training data.

### Means for Solving the Problems

In order to attain the above-described object, the information analysis apparatus of the present invention is designed as an information analysis apparatus generating a topic-related statistical model of words contained in a first text to be analyzed, including:

a related passage identification unit that compares a second text, which describes events identical to those of the first text and contains information related to a specific topic, with the first text, and identifies the parts in the first text that are related to the information of the second text,

a latent topic word extraction unit that extracts the words contained in the parts identified by the related passage identification unit, and

a statistical model generation unit that generates a statistical model estimating the extent to which the words contained in the first text occur in the specific topic,

wherein the statistical model generation unit generates the statistical model in such a manner that the extent, to which words contained in the second text and the words extracted by the latent topic word extraction unit occur in the specific topic, is made larger than the extent of occurrence of other words.

In addition, in order to attain the above-described object, the information analysis method of the present invention is a method for generating a topic-related statistical model of words contained in a first text to be analyzed, the information analysis method including the steps of:

(a) comparing a second text, which describes events identical to those of the first text and contains information related to a specific topic, with the first text, and identifying the parts in the first text that are related to the information of the second text;

(b) extracting the words contained in the parts identified in Step (a), and

(c) generating a statistical model estimating the extent to which words contained in the first text occur in the specific topic, with the statistical model generated in such a manner that the extent, to which the words contained in the second text and the words extracted in Step (b) occur in the specific topic, is made larger than the extent of occurrence of other words.

Furthermore, in order to attain the above-described object, the computer-readable storage medium of the present invention is a computer-readable storage medium having recorded thereon a software program for generating, on a computer, a topic-related statistical model of words contained in a first text to be analyzed, the program including instructions directing the computer to execute the steps of:

(a) comparing a second text, which describes events identical to those of the first text and contains information related to a specific topic, with the first text, and identifying the parts in the first text that are related to the information of the second text;

(b) extracting the words contained in the parts identified in Step (a), and

(c) generating a statistical model estimating the extent to which words contained in the first text occur in the specific topic, with the statistical model generated in such a manner that the extent, to which the words contained in the second text and the words extracted in Step (b) occur in the specific topic, is made larger than the extent of occurrence of other words.

### Effects of the Invention

Due to the above characteristics, the present invention can preclude degradation in the accuracy of estimation in a statistical model that estimates the extent of occurrence of words in a text to be analyzed even when there are differences between the words used in the text to be analyzed and in the text describing a specific topic that is used as training data.

### BRIEF DESCRIPTION OF THE DRAWINGS

FIG. 1 is a block diagram illustrating the configuration of the information analysis apparatus used in Embodiment 1 of the present invention.

FIG. 2 is a flow chart illustrating the operation of the information analysis apparatus used in Embodiment 1 of the present invention.

FIG. 3 is a block diagram illustrating the configuration of the information analysis apparatus used in Embodiment 2 of the present invention.

FIG. 4 is a flow chart illustrating the operation of the information analysis apparatus used in Embodiment 2 of the present invention.

FIG. 5 is a block diagram illustrating the configuration of the information analysis apparatus used in Embodiment 3 of the present invention.

FIG. 6 is a flow chart illustrating the operation of the information analysis apparatus used in Embodiment 3 of the present invention.

FIG. 7 is a diagram illustrating exemplary telephone call speech recognition results used in Example 1.

FIG. 8 is a diagram illustrating an exemplary Help Desk memo used in Example 1.

FIG. 9 is a diagram illustrating an exemplary situation, in which the recognition results illustrated in FIG. 7 are divided into sentence-unit segments.

FIG. 10 is a diagram illustrating an exemplary situation, in which the Help Desk memo illustrated in FIG. 8 is divided into sentence-unit segments.

FIG. 11A is a diagram illustrating morphological analysis results obtained for the Help Desk memo shown in FIG. 10 and FIG. 11B and FIG. 11C are diagrams illustrating morphological analysis results obtained based on the recognition results shown in FIG. 9.

FIG. 12A is a diagram illustrating an example of the word vectors obtained in Example 1, and FIG. 12B is a diagram illustrating an exemplary allocation table of dimensions and words used in Example 1.

FIG. 13 is a diagram illustrating an example of the results of the association processing performed in Example 1.

FIG. 14 is a diagram illustrating another example of the results of the association processing performed in Example 1.

FIG. 15 is a diagram illustrating an example of the statistical model obtained in Example 1.

FIG. 16 is a diagram illustrating another example of the statistical model obtained in Example 1.

FIG. 17 is a diagram illustrating an example of the results of the dependency analysis performed in Example 2.

FIG. 18 is a diagram illustrating an example of the common words extracted in Example 3.

FIG. 19 is a diagram illustrating an exemplary pre-built statistical model.

FIG. 20A is a diagram illustrating morphological analysis results obtained when the Help Desk memo shown in FIG. 10 is created in English. FIG. 20B and FIG. 20C are diagrams illustrating morphological analysis results obtained based on recognition results produced when the conversation shown in FIG. 7 is conducted in English.

FIG. 21A is a diagram illustrating another example of the word vectors obtained in Example 1 and FIG. 21B is a diagram illustrating another example of the allocation table of dimensions and words used in Example 1.

FIG. 22 is a diagram illustrating another example of the results of the dependency analysis performed in Example 2.

FIG. 23 is a block diagram illustrating a computer capable of running the software programs used in the embodiments and examples of the present invention.

### BEST MODE FOR CARRYING OUT THE INVENTION

### Embodiment 1

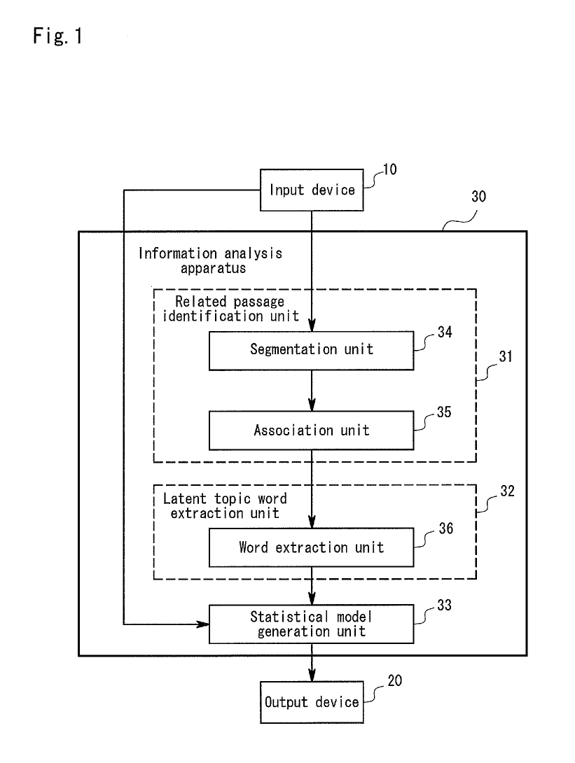

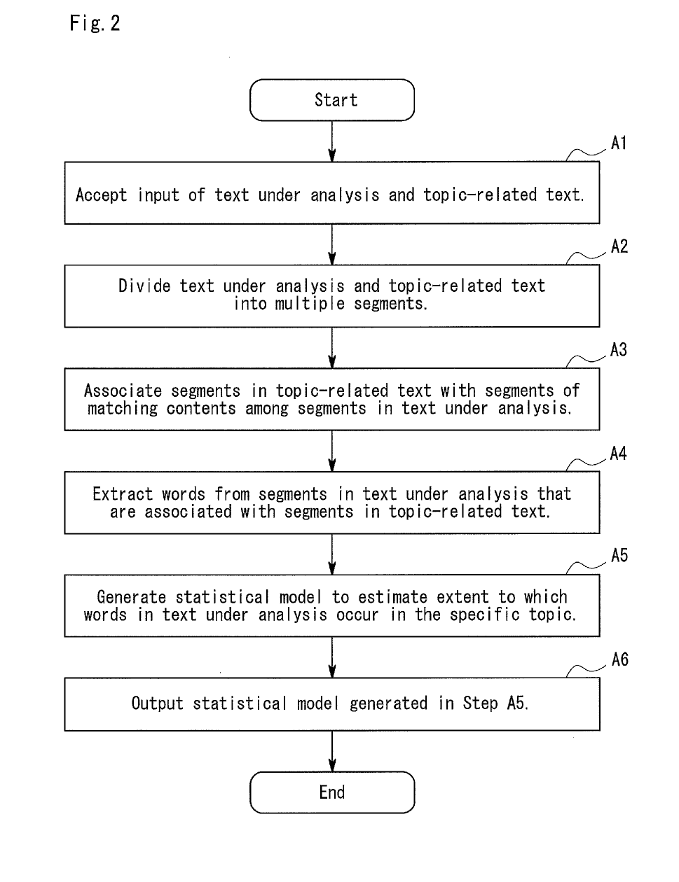

The information analysis apparatus, information analysis method, and software program used in Embodiment 1 of the present invention will be described below with reference to FIG. 1 and FIG. 2. First of all, the configuration of the information analysis apparatus used in Embodiment 1 will be described with reference to FIG. 1. FIG. 1 is a block diagram illustrating the configuration of the information analysis apparatus used in Embodiment 1 of the present invention.

The information analysis apparatus 30 used in Embodiment 1, which is illustrated in FIG. 1, is an apparatus that generates a statistical model of the words contained in a text to be analyzed (henceforth designated as “text under analysis”). As shown in FIG. 1, the information analysis apparatus 30 comprises a related passage identification unit 31, a latent topic word extraction unit 32, and a statistical model generation unit 33.

The related passage identification unit 31 compares the text under analysis with a topic-related text, which is input together with it. The topic-related text, which is text describing events identical to those of the text under analysis, is text containing information (henceforth designated as “topic information”) related to a specific topic. In addition, the related passage identification unit 31 uses the results of the comparison to identify the parts in the text under analysis that are related to the topic information.

The latent topic word extraction unit 32 extracts the words contained in the parts identified by the related passage identification unit 31. The statistical model generation unit 33 generates a statistical model that estimates the extent to which words contained in the text under analysis occur in a specific topic. In addition, when generating the statistical model, the statistical model generation unit 33 makes the extent, to which words in the topic-related text and the words extracted by the latent topic word extraction unit 32 occur in the specific topic, larger than the extent of occurrence of other words.

Thus, in the information analysis apparatus 30, the words contained in the parts of the text under analysis that are identified as related to the topic information are utilized as words related to the specific topic and a statistical model is created that reflects this fact. Accordingly, degradation in the accuracy of estimation of the statistical model estimating the extent of occurrence of words in the text to be analyzed is precluded even when there are differences between the words used in the text to be analyzed and in the topic-related text.

The suppression of degradation in the estimation accuracy of the statistical model will be discussed in further detail below. First of all, since the text under analysis and the topic-related text describe identical events, it is believed that in most cases topic information-related parts are present in the text under analysis.

In addition, it is believed that the topic information-related parts in the text under analysis are highly likely to describe the specific topic and that it should be safe to treat the words contained in these parts as words indicating the specific topic. Consequently, words that do not occur in the topic-related text, but are highly relevant to the specific topic, are supplemented when the statistical model is created, thereby allowing for a statistical model of high estimation accuracy to be generated.

Here, the configuration of the information analysis apparatus 30 used in Embodiment 1 will be described more specifically. In Embodiment 1, as shown in FIG. 1, an input device 10 and an output device 20 are connected to the information analysis apparatus 30. In addition, as described below, the information analysis apparatus 30 is implemented using a computer operating under program control.

The input device 10 is an apparatus used for inputting text to be analyzed and topic-related text into the information analysis apparatus 30. Keyboards and other devices capable of outputting text data, as well as computers capable of outputting text data via networks, etc., are suggested as specific examples of the input device 10.

In addition, in Embodiment 1, a pre-built statistical model capable of estimating the extent of occurrence of words in the specific topic, or a text other than the topic-related text that is related to the specific topic can be input into the information analysis apparatus 30 by the input device 10. It should be noted that, as used herein, the term “statistical model” refers, for example, to a list that has recorded therein data sets made up of words and the extent of occurrence of said words in a specific topic.

In addition, in Embodiment 1, examples of the text under analysis include text obtained as a result of speech recognition performed on telephone call speech at a Call Center. In such a case, text related to a specific topic (for example, “Malfunction Status”, etc.) contained in a Help Desk memo prepared based on a telephone call made to the Call Center is suggested as the topic-related text.

The output device 20 acquires the statistical model generated by the statistical model generation unit 33 and outputs (transmits) the acquired statistical model to the equipment that uses it. A computer connected via a network, etc., is suggested as a specific example of the output device 20. In addition, the output device 20 and input device 10 may be represented by the same computer.

In addition, as shown in FIG. 1, in Embodiment 1, the related passage identification unit 31 is further equipped with a segmentation unit 34 and an association unit 35. The segmentation unit 34 divides the text under analysis and the topic-related text into segments used as preset processing units. Specifically, the segmentation unit 34 divides the text under analysis and the topic-related text on a sentence-by-sentence and paragraph-by-paragraph basis. In addition, when these texts describe the contents of conversations between multiple people, they may be divided on an utterance-by-utterance or speaker-by-speaker basis.

The association unit 35 compares the text under analysis with the topic-related text for each respective segment and determines word vector-based similarity between the segments. The association unit 35 then associates the segments of the text under analysis with the segments of the topic-related text based on the determined similarity. In addition, the association unit 35 identifies the associated segments of the text under analysis as parts related to topic information in the text under analysis.

In addition, since the topic-related text and the text under analysis describe identical events, it is believed that information related to the topic information contained in the topic-related text is highly likely to be contained in the text under analysis. Therefore, assuming that information related to the topic information contained in the topic-related text is definitely contained in the text under analysis, in Embodiment 1, during association, it is preferable that the association unit 35 associate at least one segment of the text under analysis with the segments of the topic-related text.

Furthermore, in Embodiment 1, the latent topic word extraction unit 32 comprises a word extraction unit 36. The word extraction unit 36 extracts words contained in the associated segments of the text under analysis.

Furthermore, in Embodiment 1, the association unit 35, which forms part of the related passage identification unit 31, can compute association scores. The association scores show the degree of match between the identified parts of the text under analysis and the topic information they are related to. Specifically, the association scores show the degree of content match between the associated segments of the text under analysis and the segments of the topic-related text with which association is established.

In addition, in Embodiment 1, the association scores are configured such that the higher the degree of match, the higher their value. Then, the higher the association score, the closer the match between the content of the segments of the text under analysis and the segments of the topic-related text with which association is established and, as a result, the higher the likelihood that the segments of the text under analysis contain descriptions related to the specific topic.

Therefore, the computation of the association scores can be considered as performed in such a manner that words contained in passages (segments) with higher association scores occur in the specific topic to a greater extent. If the thus computed association scores are used, words that are deeply involved in the specific topic can be given preferential consideration and a statistical model of high estimation accuracy can be generated. Therefore, computing the association scores in the related passage identification unit 31 and using them in the statistical model generation unit 33 via the latent topic word extraction unit 32 is effective in generating a statistical model of high estimation accuracy.

Furthermore, the word extraction unit 36, which forms part of the latent topic word extraction unit 32, can compute topic relevance scores that indicate the degree in which the extracted words are related to the topic information. In Embodiment 1, the topic relevance scores are configured such that the higher the degree of relevance, the higher the value. In addition, the latent topic word extraction unit 32 can compute the topic relevance scores by receiving as input the number of words extracted by the word extraction unit 36 or the association scores computed by the related passage identification unit 31. In particular, upon input of the association scores, the latent topic word extraction unit 32 performs computation such that the topic relevance scores of the words present in parts with higher association scores is increased.

In addition, as described above, the topic relevance scores indicate the degree in which the words are related to the specific topic. Accordingly, the computation of the topic relevance scores can be considered as performed in such a manner that the words with higher topic relevance scores occur in the specific topic to a greater extent. If the thus computed topic relevance scores are used, the words that feature prominently in the specific topic can be given preferential consideration and a statistical model of high estimation accuracy can be generated. Therefore, computing the relevance scores in the latent topic word extraction unit 32 and using them in the statistical model generation unit 33 is effective in generating a statistical model of high estimation accuracy.

Furthermore, if the word extraction unit 36 computes topic relevance scores, the statistical model generation unit 33 generates the statistical model such that the higher the values of the corresponding topic relevance scores, the larger the extent of occurrence of the words extracted by the word extraction unit 36. Thus, a further increase in the estimation accuracy of the statistical model is achieved when the statistical model is generated with the help of topic relevance scores. It should be noted that specific examples of the association scores, topic relevance scores, and statistical models utilizing them are illustrated in the examples discussed below.

Next, the operation of the information analysis apparatus 30 used in Embodiment 1 will be described with reference to FIG. 2. FIG. 2 is a flow chart illustrating the operation of the information analysis apparatus used in Embodiment 1 of the present invention. In addition, in Embodiment 1, the information analysis method of Embodiment 1 is implemented by operating the information analysis apparatus 30. Accordingly, a description of the operation of the information analysis apparatus 30 is substituted for the description of the information analysis method used in Embodiment 1. In addition, refer to FIG. 1 as appropriate in the description that follows.

As shown in FIG. 2, at first, the segmentation unit 34 receives the text under analysis and the topic-related text as input from the input device 10 (Step A1). Next, the segmentation unit 34 divides the text under analysis and the topic-related text into segments, i.e. processing units (Step A2). Specifically, in Step A2, as described above, the segmentation unit 34 divides each text on a sentence, paragraph, utterance, or speaker basis.

Next, the association unit 35 associates the segments in the topic-related text with the segments in the text under analysis whose contents match (which contain the same information as) said segments (Step A3) and outputs the results. Specifically, in Step A3, association is performed using the above-mentioned word vector-based similarity. In Step A3, the segments of the text under analysis are associated with the segments of the topic-related text.

In Embodiment 1, the results output in Step A3 may indicate that “some of the segments in the topic-related text are not associated with any of the segments in the text under analysis”. In addition, assuming that, as mentioned above, “information related to the topic information contained in the topic-related text is definitely contained in the text under analysis”, the association unit 35 may associate at least one segment of the text under analysis with the segments of the topic-related text. Furthermore, in Step A3, the association unit 35 may compute the above-described association scores and output the association scores along with the association results.

Next, the latent topic word extraction unit 32 receives the results output by the related passage identification unit 31 and extracts the words contained in the parts identified in the text under analysis (Step A4). The words extracted in Step A4 correspond to the words that are highly likely to be related to the specific topic.

Specifically, in Step A4, based on the association results obtained in Step A3, the word extraction unit 36 identifies the segments that are associated with the segments of the topic-related text among the segments in the text under analysis. The identified segments represent passages related to the topic information of the topic-related text and the word extraction unit 36 extracts the words from the identified segments as words that are highly likely to be related to the specific topic.

In addition, the word extraction unit 36 can compute the above-described topic relevance scores. In this case, the word extraction unit 36 outputs the topic relevance scores corresponding to the extracted words together with the extracted words.

Next, the statistical model generation unit 33 receives the topic-related text from the input device 10 and receives the extraction results obtained in Step A4 from the latent topic word extraction unit 32. The statistical model generation unit 33 then generates a statistical model that estimates the extent to which words in the text under analysis occur in the specific topic (Step A5). In addition, in Step A5, the statistical model generation unit 33 generates the statistical model such that the extent, to which words in the topic-related text and the words extracted in Step A4 occur in the specific topic, is made larger than the extent of occurrence of other words.

When generating the statistical model In Step A5, the statistical model generation unit 33 can also use other pre-built statistical models for the specific topic. In addition, in order to train the statistical model to be generated, the statistical model generation unit 33 can also use training data other than the topic-related text. Furthermore, in such cases, the statistical model generation unit 33 generates the statistical model in such a manner that the extent, to which the words in the topic-related text and the words extracted in Step A4 occur in the specific topic, is made larger than the extent of occurrence of other words.

In addition, when the words in the text under analysis are input into the statistical model generated in Step A5, the model outputs the extent of occurrence of the input words in the topic to be identified. Furthermore, in Embodiment 1, it is possible to use probability indicating the tendency of words to occur as the extent of occurrence. In such a case, the value of the extent of occurrence increases when, for example, the input words tend to occur more often, and decreases when they tend to occur less often.

After that, the statistical model generation unit 33 outputs the statistical model generated in Step A5 to the output device 20 (Step A6). The execution of Step A6 concludes processing in the information analysis apparatus 30. It should be noted that the output device 20 outputs the acquired statistical model to other equipment that utilizes the statistical model. In that equipment, the computation of the extent of word occurrence is carried out using the statistical model.

In addition, the software program used in Embodiment 1 may be any software program as long as it directs a computer to execute Steps A1-A6 illustrated in FIG. 2. The information analysis apparatus 30 and information analysis method used in Embodiment 1 can be implemented by installing and running this software program on a computer. In such a case, the CPU (Central Processing Unit) of the computer functions and performs processing as the related passage detection unit 31, latent topic word extraction unit 32, and statistical model generation unit 33.

As described above, in Embodiment 1, the text under analysis and the topic-related text describe identical events. Therefore, it is believed that the associated parts between the segments of both texts are related to identical information and, in addition, are highly likely to be related to the specific topic. Under this assumption, the words in the segments of the text under analysis that are associated with the segments of the topic-related text are considered to be words occurring in connection with the specific topic. In addition, the statistical model is generated such that the extent to which these words occur in the specific topic is increased.

For this reason, in accordance with Embodiment 1, the statistical model is generated by supplementing words that do not occur in the topic-related text, but are related to the topic. Accordingly, an increase in the estimation accuracy of the statistical model is achieved even if the parts describing the specific topic are not identical and, furthermore, even if there are differences between the words used in the topic-related text and in the text under analysis.

### Embodiment 2

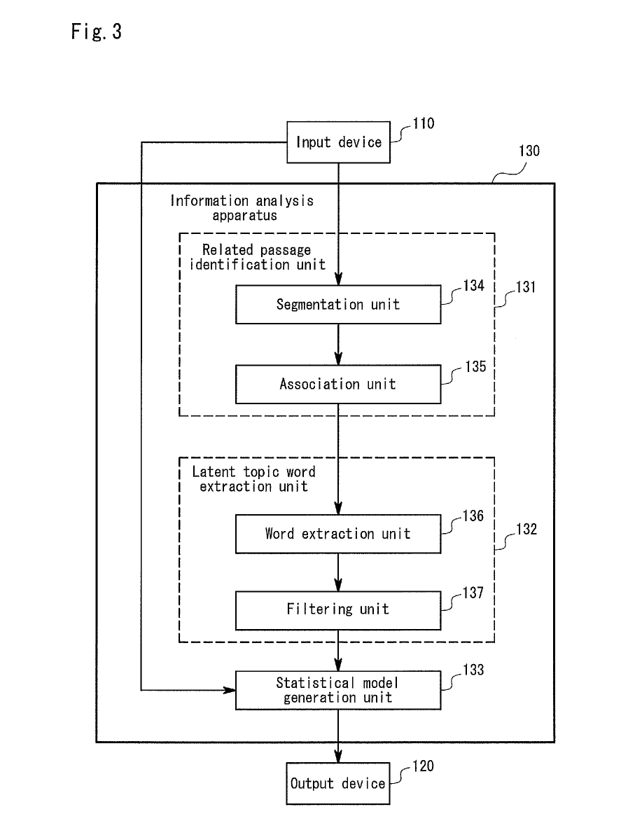

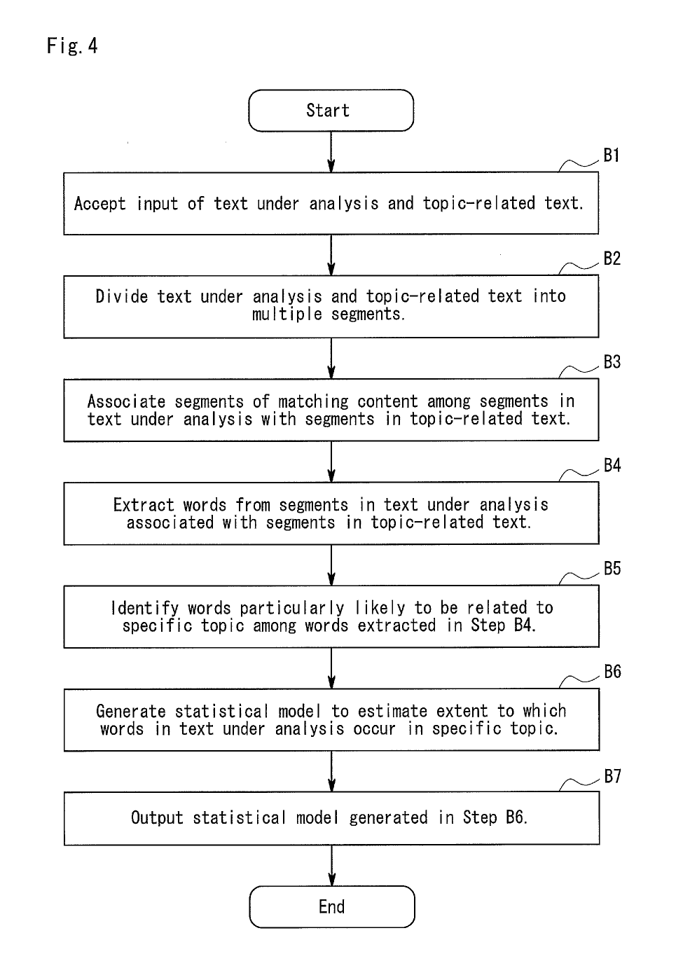

Next, the information analysis apparatus, information analysis method, and software program used in Embodiment 2 of the present invention will be described with reference to FIG. 3 and FIG. 4. First of all, the configuration of the information analysis apparatus used in Embodiment 2 will be described with reference to FIG. 3. FIG. 3 is a block diagram illustrating the configuration of the information analysis apparatus used in Embodiment 2 of the present invention.

In the same manner as the information analysis apparatus 30 used in Embodiment 1 illustrated in FIG. 1, the information analysis apparatus 130 used in Embodiment 2, which is illustrated in FIG. 3, is an apparatus that generates a statistical model of the words contained in a text under analysis.

However, in Embodiment 2, unlike Embodiment 1, the latent topic word extraction unit 132 comprises a filtering unit 137 in addition to the word extraction unit 136. The filtering unit 137 identifies the words that are particularly likely to be related to the specific topic in the parts identified by the related passage identification unit 131.

Specifically, the filtering unit 137 identifies the words that meet certain conditions among the words contained in the associated segments of the text under analysis. Words corresponding to any of the following descriptions (1)-(6) are suggested as the words that meet certain conditions. In Embodiment 2, the words identified by the filtering unit 137 correspond to the words extracted by the latent topic word extraction unit 132.

(1) Words of predetermined types.
(2) Words whose frequency of occurrence is not lower than a preset threshold value.
(3) Words located in the phrasal units in which the common words are located.
(4) Words whose distance to the common words is not larger than a predetermined threshold value.
(5) Words located in phrasal units whose dependency distance from the phrasal units containing the common words is not larger than a predetermined threshold value.
(6) Words corresponding to two or more of the above-described descriptions (1)-(5).

In addition, the above-mentioned common words are words that appear in the same sense in the parts identified by the related passage identification unit 131 and the topic information of the topic-related text. Specifically, words that have similar import, words that are synonym, or words that match about surface base forms and parts of speech, with words indicating the topic information of the topic-related text, among the words contained in the parts identified by the related passage identification unit 131, can be used as the common words.

It should be noted that, except as stated above, the information analysis apparatus 130 is configured in the same manner as the information analysis apparatus 30 in Embodiment 1. In other words, the segmentation unit 134, association unit 135, and word extraction unit 136 operate in the same manner as, respectively, the segmentation unit 34, association unit 35, and word extraction unit 36 illustrated in FIG. 1 in Embodiment 1.

In addition, with the exception of utilizing the results output by the filtering unit 137, the statistical model generation unit 133 operates in the same manner as the statistical model generation unit 33. Furthermore, the input device 110 and output device 120 used in Embodiment 2 are similar to the input device 10 and output device 20 used in Embodiment 1.

Next, the operation of the information analysis apparatus 130 used in Embodiment 2 will be described with reference to FIG. 4. FIG. 4 is a flow chart illustrating the operation of the information analysis apparatus used in Embodiment 2 of the present invention. In addition, in Embodiment 2, the information analysis method of Embodiment 2 is implemented by operating the information analysis apparatus 130. Accordingly, a description of the operation of the information analysis apparatus 130 is substituted for the description of the information analysis method used in Embodiment 2. In addition, refer to FIG. 3 as appropriate in the description that follows.

As shown in FIG. 4, at first, the segmentation unit 134 receives the text under analysis and the topic-related text as input from the input device 110 (Step B1) and divides them into multiple segments (Step B2). It should be noted that Steps B1 and B2 are the same steps as Steps A1 and A2 shown in FIG. 2.

Next, the association unit 135 associates the segments in the topic-related text with the segments in the text under analysis whose contents match said segments (Step B3). Subsequently, the word extraction unit 136 extracts the words contained in the segments of the text under analysis that are associated with segments in the topic-related text (Step B4).

It should be noted that Steps B3 and B4 are the same steps as Steps A3 and A4 shown in FIG. 2. In addition, in Embodiment 2, the association scores can be computed in Step B3 and topic relevance scores can be computed in Step B4.

Next, the filtering unit 137 identifies the words that are particularly likely to be related to the specific topic among the words extracted in Step B4, i.e. the words that correspond to any of the descriptions (1)-(6) above (Step B5). It should be noted that in Step B5 the filtering unit 137 can also output the identified words along with the topic relevance scores computed in Step B4 to the statistical model generation unit 133. In addition, in Step B5, it can compute the topic relevance scores once again based on the conditions in (1)-(6) above and output them to the statistical model generation unit 133.

In Embodiment 2 the topic relevance scores also indicate the degree in which words are related to a specific topic, as described in Embodiment 1. Accordingly, if computation is carried out such that the extent of occurrence of words with higher topic relevance scores in the specific topic is increased, the words that feature prominently in the specific topic can be given preferential consideration and a statistical model of high estimation accuracy can be generated. Therefore, outputting the relevance scores from the filtering unit 137 and using the relevance scores in the statistical model generation unit 133 is effective in generating a statistical model of high estimation accuracy.

Next, the statistical model generation unit 133 receives the topic-related text from the input device 110, receives the results obtained in Step B5 from the latent topic word extraction unit 132 (filtering unit 137), and generates a statistical model (Step B6). After that, the statistical model generation unit 133 outputs the statistical model generated in Step B6 to the output device 120 (Step B7). The execution of Step B7 concludes processing in the information analysis apparatus 130. It should be noted that Steps B6 and B7 are respectively the same steps as Steps A5 and A6 shown in FIG. 2.

In addition, the software program used in Embodiment 2 may be any software program as long as it directs a computer to execute Steps B1-B7 shown in FIG. 4. The information analysis apparatus 130 and information analysis method used in Embodiment 2 can be implemented by installing and running this software program on a computer. In such a case, the CPU (Central Processing Unit) of the computer functions and performs processing as the related passage detection unit 131, latent topic word extraction unit 132, and statistical model generation unit 133.

In Embodiment 2, as described above, words that are particularly likely to be related to the specific topic are identified by the filtering unit 137 among the words in the segments of the text under analysis that are associated with the segments of the topic-related text. In addition, the statistical model is generated such that the extent to which these identified words occur in the specific topic is increased. For this reason, the extent of occurrence of the words whose relevance to the specific topic is low does not increase in the statistical model. As a result, the estimation accuracy of the statistical model is enhanced even more in Embodiment 2 in comparison with Embodiment 1.

### Embodiment 3

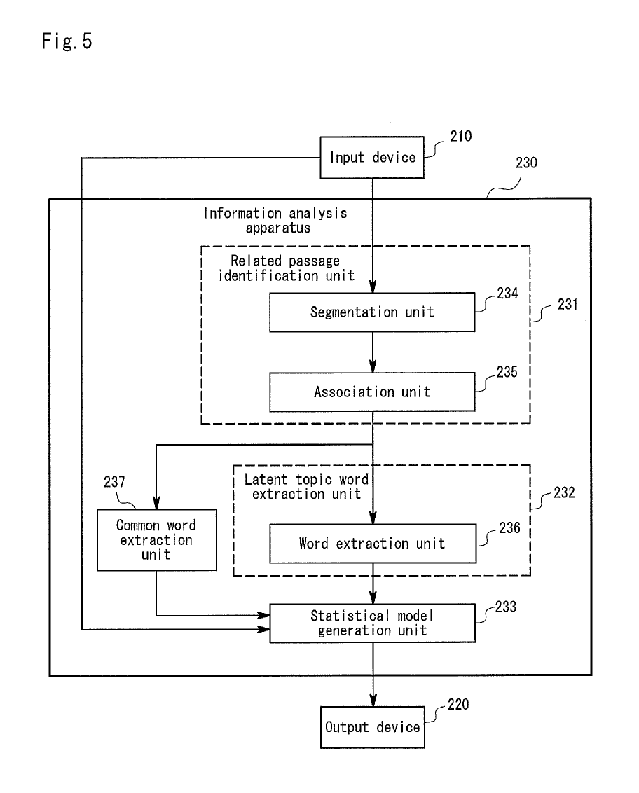

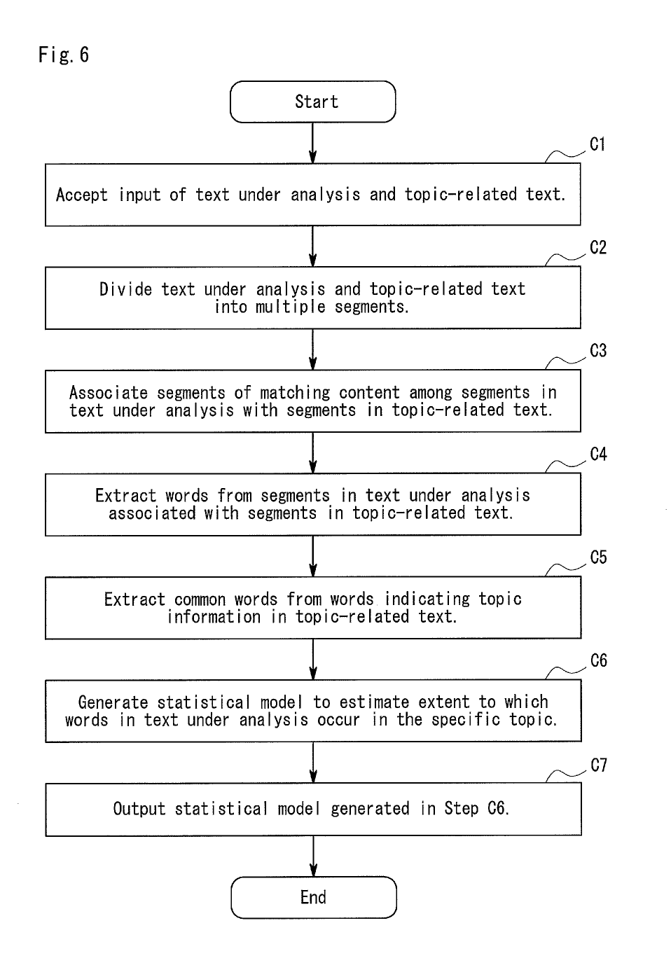

Next, the information analysis apparatus, information analysis method, and software program used in Embodiment 3 of the present invention will be described with reference to FIG. 5 and FIG. 6. First of all, the configuration of the information analysis apparatus used in Embodiment 3 will be described with reference to FIG. 5. FIG. 5 is a block diagram illustrating the configuration of the information analysis apparatus used in Embodiment 3 of the present invention.

In the same manner as the information analysis apparatus 30 used in Embodiment 1 illustrated in FIG. 1, the information analysis apparatus 230 used in Embodiment 3, which is illustrated in FIG. 5, is an apparatus that generates a statistical model of the words contained in a text under analysis.

However, in Embodiment 3, unlike Embodiment 1, the information analysis apparatus 230 comprises a common word extraction unit 237. In addition, unlike the statistical model generation unit 33 shown in FIG. 1, the statistical model generation unit 233 generates a statistical model using the results output from the common word extraction unit 237.

The common word extraction unit 237 extracts common words that appear in the same sense from the parts identified by the related passage identification unit 231 and the topic information of the topic-related text. In Embodiment 3, the expression “common words” has the same meaning as the expression “common words” in Embodiment 2. Specifically, first of all, the common word extraction unit 237 identifies the words that indicate the topic information of the topic-related text. Next, among the identified words, the common word extraction unit 237 identifies words that have similar import, words that are synonym, or words that match about surface base forms and parts of speech, with words contained in the associated segments of the text under analysis. The common word extraction unit 237 then extracts the ultimately identified words as the common words.

In addition, the statistical model generation unit 233 generates the statistical model such that the extent, to which the words in the topic-related text and the words extracted by the latent topic word extraction unit 232 respectively occur in the specific topic, is made larger than the extent of occurrence of other words. Furthermore, in Embodiment 3, the statistical model generation unit 233 generates the statistical model such that the extent of occurrence of the common words identified by the common word extraction unit 237 is made larger than the extent of occurrence of words other than the common words in the topic-related text.

In addition, the common word extraction unit 237 can compute likelihood-of-use scores. The likelihood-of-use scores are numerical values indicating the likelihood of the extracted common words being used in the parts related to the specific topic in the text under analysis. The likelihood-of-use scores are configured such that the higher the likelihood of use, the higher their values. Furthermore, in such a case, the statistical model generation unit 233 generates the statistical model such that the higher the values of the corresponding likelihood-of-use scores, the larger the extent of occurrence of the extracted common words in the specific topic.

The common word extraction unit 237 can compute the likelihood-of-use scores by receiving as input the number of words extracted by the common word extraction unit 237 and the association scores computed by the related passage identification unit 231. In addition, as described above, the association scores indicate the degree of content match between the segments of the text under analysis and the segments of the topic-related text with which association is established, and their values increase when the degree of match is higher. Therefore, the likelihood of describing the specific topic is made higher for words contained in passages with higher association scores. For this reason, upon input of the association scores, computation is performed such the likelihood-of-use scores are made higher for the common words present in parts with higher association scores. In such a case, the likelihood-of-use scores are suitable as scores indicating the likelihood of being used in the parts related to the specific topic in the text under analysis.

It should be noted that, except as stated above, the information analysis apparatus 230 is configured in the same manner as the information analysis apparatus 30 in Embodiment 1. In other words, the segmentation unit 234, association unit 235, and word extraction unit 236 operate in the same manner as, respectively, the segmentation unit 34, association unit 35, and word extraction unit 36 illustrated in FIG. 1 in Embodiment 1.

In addition, with the exception of utilizing the results output by the common word extraction unit 237, the statistical model generation unit 233 operates in the same manner as the statistical model generation unit 33. Furthermore, the input device 210 and output device 220 used in Embodiment 3 are similar to the input device 10 and output device 20 used in Embodiment 1.

Next, the operation of the information analysis apparatus 230 used in Embodiment 3 will be described with reference to FIG. 6. FIG. 6 is a flow chart illustrating the operation of the information analysis apparatus used in Embodiment 3 of the present invention. In addition, in Embodiment 3, the information analysis method of Embodiment 3 is implemented by operating the information analysis apparatus 230. Accordingly, a description of the operation of the information analysis apparatus 230 is substituted for the description of the information analysis method used in Embodiment 3. In addition, refer to FIG. 5 as appropriate in the description that follows.

As shown in FIG. 6, at first, the segmentation unit 234 receives the text under analysis and the topic-related text as input from the input device 210 (Step C1) and divides them into multiple segments (Step C2). It should be noted that Steps C1 and C2 are the same steps as Steps A1 and A2 shown in FIG. 2.

Next, the association unit 235 associates the segments in the topic-related text with the segments in the text under analysis whose contents match said segments (Step C3). Subsequently, the word extraction unit 236 extracts the words contained in the segments of the text under analysis that are associated with segments in the topic-related text (Step C4).

It should be noted that Steps C3 and C4 are the same steps as Steps A3 and A4 shown in FIG. 2. In addition, in Embodiment 3, the association scores can also be computed in Step C3 and topic relevance scores can also be computed in Step C4.

Next, the common word extraction unit 237 receives the results of association between the text under analysis and the topic-related text analyzed in Step C3 and extracts common words from the words indicating the topic information of the topic-related text (Step C5).

In addition, the common word extraction unit 237 can compute likelihood-of-use scores in Step C5. In such a case, the common word extraction unit 237 can output the extracted likelihood-of-use scores to the statistical model production unit 233 along with the common words. In addition, in Embodiment 3, Step C4 and Step C5 may be executed simultaneously; otherwise, Step C4 may be executed after executing Step C5. There are no particular limitations on the order of execution of Step C4 and Step C5.

Next, after receiving the topic-related text from the input device 210 and receiving the words extracted in Step C4 from the latent topic word extraction unit 232, the statistical model generation unit 233 receives the common words extracted in Step C5 from the common word extraction unit 237. The topic model generation unit 233 then uses the data to generate a statistical model (Step C6).

In addition, in Step C6, the statistical model generation unit 233 generates the statistical model such that the extent, to which the words in the topic-related text and the words extracted in Step C4 respectively occur in the specific topic, is made larger than the extent of occurrence of other words. Furthermore, at such time, the statistical model generation unit 233 generates the statistical model such that the extent of occurrence of the common words extracted in Step C5 is made larger than the extent of occurrence of words other than the common words in the topic-related text.

In addition, in Step C6, in the same manner as in Step A5, when generating the statistical model, the statistical model generation unit 233 can also use other pre-built statistical models for the specific topic. In addition, in order to train the statistical model to be generated, the statistical model generation unit 233 can also use training data other than the topic-related text. It should be noted that, in such cases, the statistical model generation unit 233 generates the statistical model in such a manner that the extent, to which the words in the topic-related text and the words extracted in Step C4 occur in the specific topic, is made larger than the extent of occurrence of other words. Furthermore, at such time, the generation of the statistical model by the statistical model generation unit 233 is carried out in such a manner that the extent of occurrence of the common words extracted in Step C5 is made larger than the extent of occurrence of words other than the common words contained in the topic-related text.

After that, the statistical model generation unit 233 outputs the statistical model generated in Step C6 to the output device 220 (Step C7). The execution of Step C7 concludes processing in the information analysis apparatus 230. It should be noted that Step C7 is the same as Step A6 shown in FIG. 2.

In addition, the software program used in Embodiment 3 may be any software program as long as it directs a computer to execute Steps C1-C7 shown in FIG. 6. The information analysis apparatus 230 and information analysis method used in Embodiment 3 can be implemented by installing and running this software program on a computer. In such a case, the CPU (Central Processing Unit) of the computer functions and performs processing as the related passage detection unit 231, latent topic word extraction unit 232, statistical model generation unit 233, and common word extraction unit 237.

Incidentally, the words contained in the topic-related text are sometimes present in parts other than the parts describing specific topic in the text under analysis. In such a case, said words are contained in the topic-related text and, for this reason, the extent to which said words in the text under analysis occur in the specific topic has a value higher than the actual value, which may degrade the accuracy of estimation of the statistical model.

By contrast, in Embodiment 3, the common words are extracted by the common word extraction unit 237 and the statistical model generation unit 233 then generates the statistical model such that the extent of occurrence of the common words is increased. For this reason, according to Embodiment 3, even in the presence of the above-described situation, the extent of occurrence of the words used in parts other than the parts describing the specific topic in the text under analysis becomes relatively low in comparison with that of the words (common words) used in the parts describing the specific topic in the text under analysis. Consequently, Embodiment 3, prevents inaccuracies in the value of the extent of occurrence of the words contained in the text under analysis.

In addition, in Embodiment 3, the information analysis apparatus 230 may comprise the filtering unit 137 shown in FIG. 3. In such a case, a step similar to Step B5 shown in FIG. 4 is executed after Step C4 shown in FIG. 6 or in parallel with Step C5. This makes it possible to obtain the effects described in Embodiment 2 in the information analysis apparatus 230.

### Example 1

### Operation of Example 1

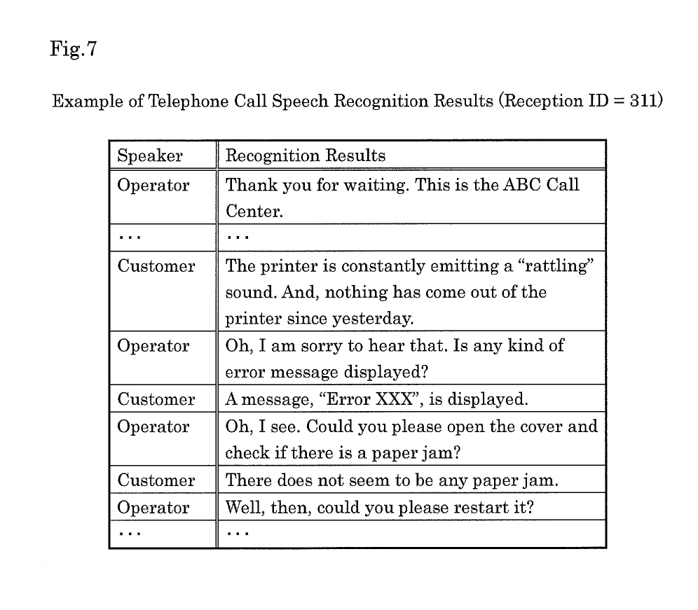

A specific example of the information analysis apparatus and information analysis method of Embodiment 1 is described below with reference to FIG. 7-FIG. 16 and FIG. 19. In addition, below, the operation of the text processing apparatus used in Embodiment 1 is described using the flow chart shown in FIG. 2. In addition, refer to FIG. 1 as appropriate.

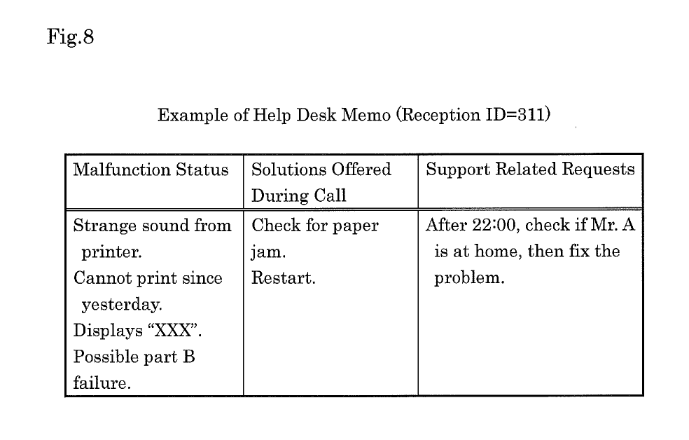

FIG. 7 is a diagram illustrating exemplary telephone call speech recognition results used in Example 1. FIG. 8 is a diagram illustrating an exemplary Help Desk memo used in Example 1. As shown in FIG. 7, in Example 1, the text under analysis is a speech-recognized text obtained by running speech recognition on telephone call speech at a Call Center. In addition, as shown in FIG. 8, the topic-related text is the text entered in the “Malfunction Status” field in a Help Desk memo prepared based on the conversations recognized in the speech-recognized text shown in FIG. 7. Furthermore, in Example 1, the specific topic is configured as the underlying topic of the field “Malfunction Status” of the Help Desk memo illustrated in FIG. 8.

In addition, as shown in FIG. 7 and FIG. 8, since the text under analysis and the topic-related text describe identical events, in most cases, parts related to the topic-related text are present in the text under analysis. The parts related to the topic-related text are the parts concerning the specific topic in the text under analysis.

However, the related parts in the text under analysis and the topic-related text are not identical, and the words used in them are different as well. For example, the words “shaking”, “sound”, and “error” used in the part corresponding to “Malfunction Status” in the text under analysis illustrated in FIG. 7, are not used in the topic-related text illustrated in FIG. 8.

The process of generating a statistical model of the words found in the speech-recognized text (Receipt ID=311) shown in FIG. 7 in Example 1, which is used to estimate the extent of occurrence in the topic “Malfunction Status” of the Help Desk memo illustrated in FIG. 8, is described below.

[Step A1]

First of all, the input device 10 inputs a speech-recognized text obtained from a telephone call as the text under analysis and, in addition, the text describing the specific topic, “Malfunction Status”, from a Help Desk memo created from the telephone call, as the topic-related text into the information analysis apparatus 30. As a result, the segmentation unit 34 receives the text under analysis and the topic-related text as input from the input device 10.

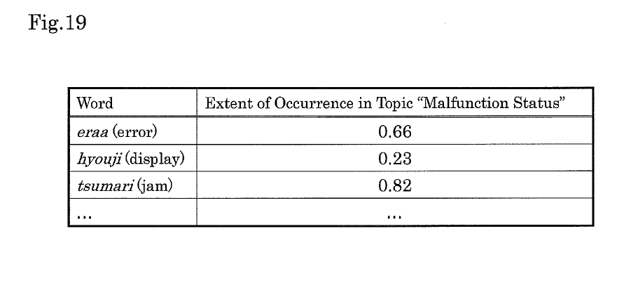

In addition, in the present example, the information analysis apparatus 30 can receive a pre-built statistical model, which is illustrated in FIG. 19, as input from the input device 10. FIG. 19 is a diagram illustrating an exemplary pre-built statistical model. The statistical model shown in FIG. 19 is a statistical model that estimates the extent of occurrence of words in the specific topic. In addition, as shown in FIG. 19, this statistical model, which is configured in the form of tabular data, has a list of data sets made up of words and the extent of occurrence of said words in the specific topic. Furthermore, in the present example, the information analysis apparatus 30 can receive text on the specific topic other than the topic-related text as input from the input device 10. For example, text that is different from the text with Receipt ID 311 and is located in the Malfunction Status portion of the Help Desk memo, is suggested as the aforementioned text.

Subsequently, the related passage identification unit 31 identifies the parts pertaining to the topic information described in the topic-related text (Step A2 and A3) in the text under analysis.

[Step A2] Specifically, the segmentation unit 34 divides the text under analysis and the topic-related text into segments, i.e. processing units. For example, when the segments used as analytical units are sentences, sentence separators are predetermined in advance and the segmentation unit 34 carries out segmentation by considering text between the separators as a single segment.

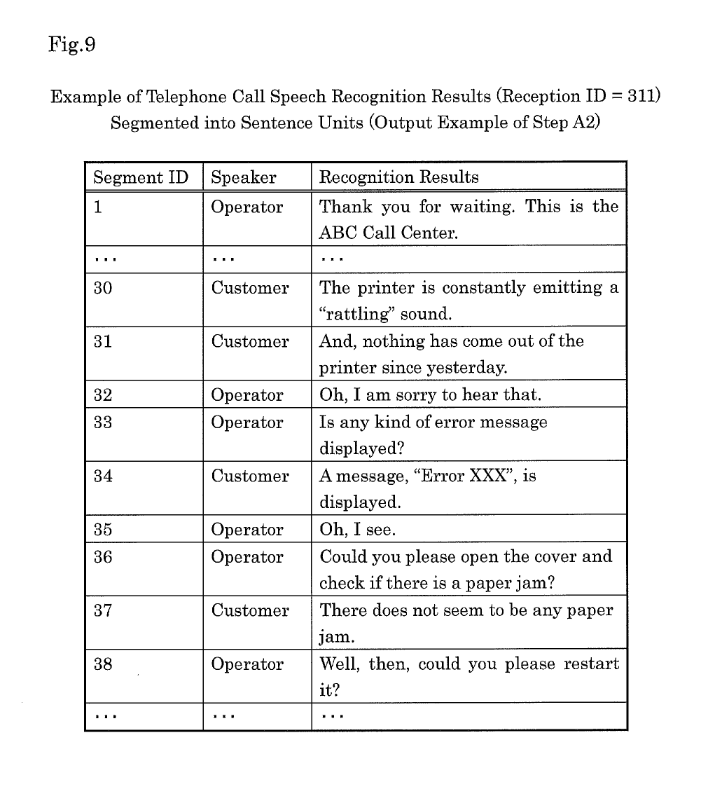

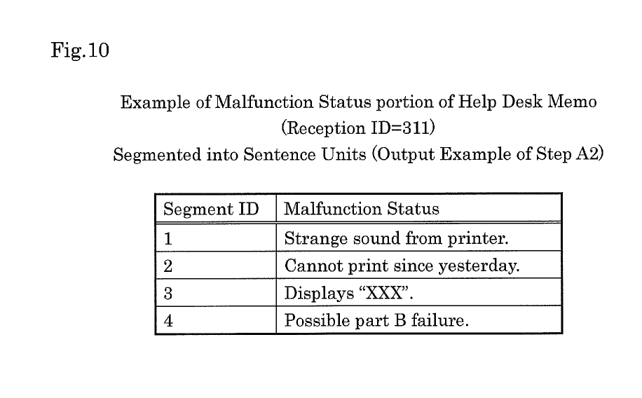

When the texts shown in FIG. 7 and FIG. 8 are segmented with the help of “.” and“?” used as separators, the results of the segmentation are as shown, respectively, in FIG. 9 and FIG. 10. FIG. 9 is a diagram illustrating an exemplary situation, in which the recognition results illustrated in FIG. 7 are divided into sentence-unit segments. FIG. 10 is a diagram illustrating an exemplary situation, in which the Help Desk memo illustrated in FIG. 8 is divided into sentence-unit segments.

In addition, when the text to be segmented is speech-recognized text, the segmentation unit 34 can use the results of silent interval detection etc. by the speech recognition engine in order to divide it into segments. In addition, in such a case, the segmentation unit 34 can perform segmentation using the output utterances as a unit.

Furthermore, the segmentation unit 34 can also perform segmentation using the information provided in the text to be segmented. For example, as shown in FIG. 7, when the speakers participating in the dialog can be identified in a speech-recognized text, the segmentation unit 34 may perform segmentation by considering each parts belonging to the same speaker as a segment. It should be noted that, in FIG. 7, the rows of the table correspond to utterances by the same speaker.

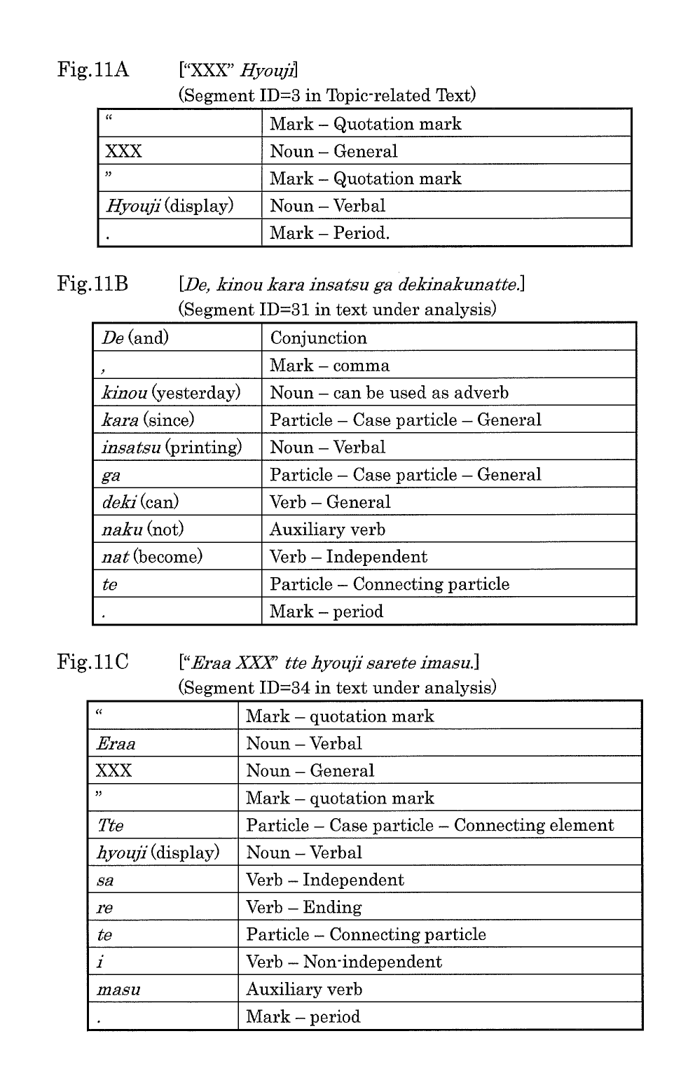

In addition, if the text has been pre-segmented into explicit and formal chunks along paragraph boundaries, etc., the segmentation unit 34 can perform segmentation by considering the chunks as segments. It should be noted that in the present invention, the unit of segmentation can be specified at the user's discretion and may be different from the units described in Embodiment 1 and Example 1.

[Step A3] Subsequently, the association unit 35 associates the segments in the topic-related text with the segments in the text under analysis contain the same information as said segments. As an example, processing involving associating segment ID=3 in the topic-related text shown in FIG. 10 with a segment containing the same information among the segments in the text under analysis shown in FIG. 9 will be described below with reference to FIG. 11. FIG. 11A is a diagram illustrating morphological analysis results obtained for the Help Desk memo shown in FIG. 10 and FIG. 11B and FIG. 11C are diagrams illustrating morphological analysis results obtained based on the recognition results shown in FIG. 9.

First of all, the association unit 35 runs morphological analysis on segment ID=3 in the topic-related text and on the segments of the text under analysis. The morphological analysis results for segment ID=3 in the topic-related text and for some of the segments in the text under analysis are shown in FIG. 11A-FIG. 11C. It should be noted that FIG. 11A-FIG. 11C illustrate a case, in which the conversation is conducted in Japanese and the topic-related text is created in Japanese as well.

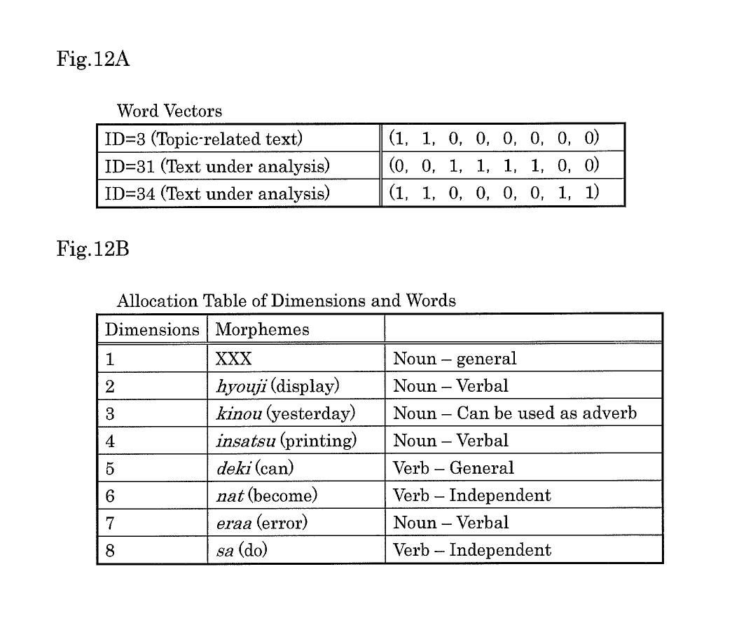

Next, the association unit 35 uses independent words among the morphemes to generate vectors, in which a single morpheme corresponds to a single vector dimension and the overall number of morphemes corresponds to vector dimensionality. Specifically, word vectors, e.g. such as those shown in FIG. 12A, are generated for every segment by the association unit 35 using the allocation table of dimensions and words shown in FIG. 12B. At such time, when morphemes whose dimensions are specified in the allocation table of dimensions and words are present among the morphemes that form part of the segments, the association unit 35 sets the value of the elements with the corresponding dimensions to 1, and sets the value of the elements with the corresponding dimensions to 0 when none is present. FIG. 12A is a diagram illustrating an example of the word vectors obtained in Example 1, and FIG. 12B is a diagram illustrating an exemplary allocation table of dimensions and words used in Example 1.

Next, the association unit 35 computes the cosine similarity of the generated word vectors of the segments of the topic-related text and the word vectors of the segments in the text under analysis. For example, the cosine similarity cosine (ID=3, ID=31) of the above-mentioned ID=3 (topic-related text) and ID=31 (text under analysis) is represented by Equation 1 below. In addition, the cosine similarity of ID=3 and ID=34 (text under analysis) is represented by Equation 2 below.

$$\begin{matrix}cosine ( ID = 3 , ID = 31 ) = \frac{0}{\sqrt{2} * \sqrt{4}} = 0 & [ Eq . 1 ] \\ cosine ( ID = 3 , ID = 34 ) = \frac{2}{\sqrt{2} * \sqrt{4}} = 0.7 & [ Eq . 2 ]\end{matrix}$$

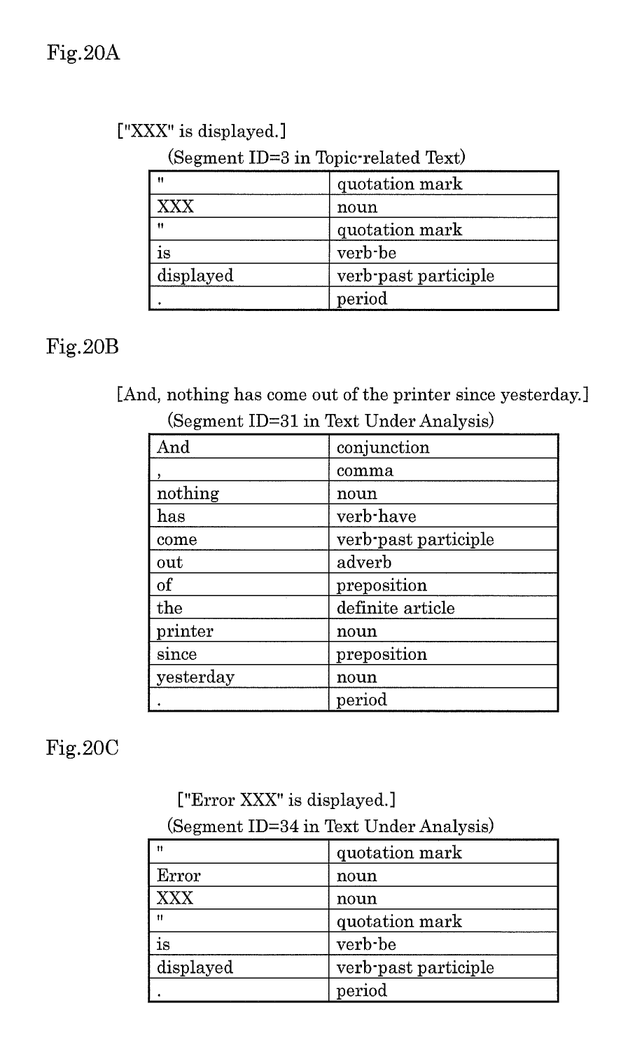

Further, if the conversation is conducted in English and the topic-related text is also created in English, the morphological analysis results for the Help Desk memo and the morphological analysis results obtained based on the recognition results are as shown in FIG. 20A-FIG. 20C. FIG. 20A is a diagram illustrating morphological analysis results obtained when the Help Desk memo shown in FIG. 10 is created in English. FIG. 20B and FIG. 20C are diagrams illustrating morphological analysis results obtained based on recognition results produced when the conversation shown in FIG. 7 is conducted in English.

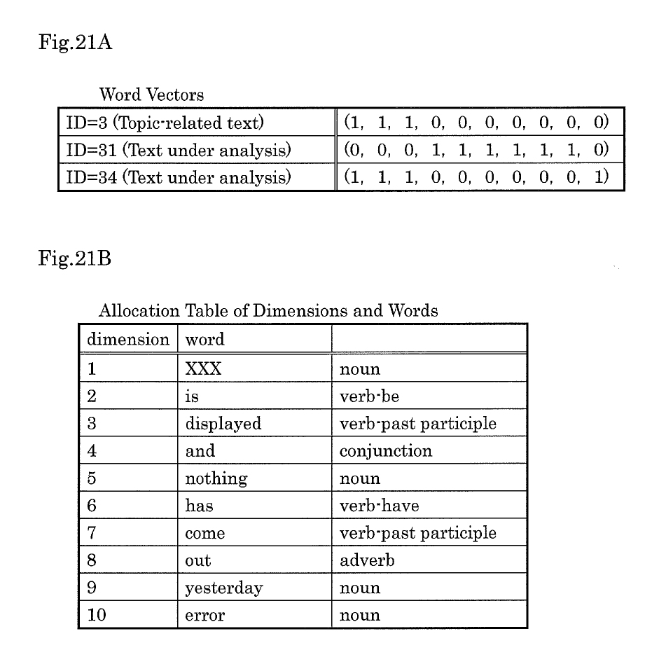

Furthermore, the allocation table shown in FIG. 21B is used and word vectors shown in FIG. 21A are created when the conversation is conducted in English and the topic-related text is also created in English. FIG. 21A is a diagram illustrating another example of the word vectors obtained in Example 1 and FIG. 21B is a diagram illustrating another example of the allocation table of dimensions and words used in Example 1. In addition, in the word vector example illustrated in FIG. 21A, the value of cosine similarity cosine (ID=3, ID=31) is 0 (zero) and value of cosine similarity cosine (ID=3, ID=34) is 0.87.

Next, when the computed cosine similarity is not lower than a threshold value, the association unit 35 associates the segments of the text under analysis and the segments of the topic-related text. As a result, processing is performed in the association unit 35. It should be noted that the threshold value is configured in advance using, e.g. training data, preliminary experiments, etc.

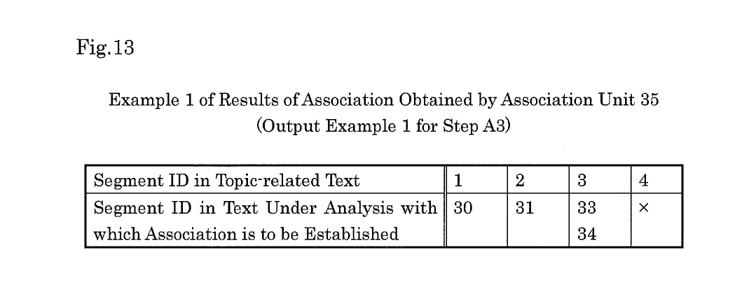

Here, an example of the results obtained via the above-described processing is shown in FIG. 13. FIG. 13 is a diagram illustrating an example of the results of the association processing performed in Example 1. In FIG. 13, the IDs under the segment IDs of the topic-related text are the associated segment IDs of the text under analysis. In addition, the associated segments of the text under analysis are not limited to a single segment and multiple segments may be associated with a single segment of the topic-related text. It should be noted that in FIG. 13 the symbol “x” indicates that none of the segments in the text under analysis is associated therewith.

In addition, in Example 1, as mentioned in Embodiment 1, the text under analysis and the topic-related text are characterized by describing identical events. Accordingly, a constraint may be configured such that, based on this feature, during the association operation in Example 1, the association unit 35 associates at least one segment of the text under analysis with the segments of the topic-related text. In such a case, even those segments of the topic-related text, for which the above-described cosine similarity is not higher than the threshold value, are associated with the segments of the text under analysis, for which the cosine similarity is highest. This precludes the occurrence of anomalous situations, in which the segments of the topic-related text are not associated with any of the segments in the text under analysis because, despite the fact that the corresponding segments of the text under analysis do exist, there are considerable differences between the words used and the cosine similarity is low.

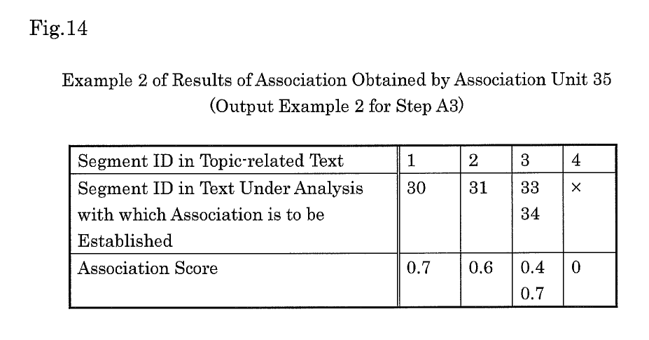

Furthermore, the association unit 35 can also output “the association scores” shown in FIG. 14 along with the association results. The association scores represent the degree of content match defining the closeness of the mutual association between segments in the text under analysis and segments in the topic-related text. In Example 1, for instance, cosine similarity is used as the “association score”. FIG. 14 is a diagram illustrating another example of the results of the association processing performed in Example 1.

In addition, since the text under analysis and the topic-related text describe identical events, it is believed that in most cases parts related to the topic related text are present in the text under analysis. Accordingly, it is believed that the association of segments related to identical information can be done using regular alignment between segments. Therefore, an association unit 35 capable of performing the traditional alignment process is suggested as another example of the association unit 35.

For example, an example of the traditional alignment process is described in following Reference 1. In the alignment process disclosed in Reference 1, association can be performed if segments of the text under analysis and segments of the topic-related text are used as input. In addition, in the alignment process disclosed in Reference 1, an alignment score (a score indicating that the higher its value, the greater the extent of association between two segments) is calculated for two segments and alignment is performed based on the resultant values. Therefore, if an alignment process is performed by the association unit 35, alignment scores may be used as the “association scores”.

### REFERENCE 1

R. Barzilay and N. Elhadad, “Sentence Alignment for Monolingual Comparable Corpora”, In Proceedings of the Conference on Empirical Methods in Natural Language Processing (EMNLP 2003), pp. 25-32, 2003.

[Step A4]

Subsequently, the latent topic word extraction unit 32 (word extraction unit 36) receives the results from the related passage identification unit 31 and extracts words that are highly likely to be related to the specific topic from passages associated with the topic-related text in the text under analysis. Specifically, the word extraction unit 36 receives the results of association of the text under analysis with the topic-related text obtained in Step A3. The word extraction unit 36 then identifies segments associated with segments in the topic-related text among the segments of the text under analysis as passages related to the topic-related text. Next, the word extraction unit 36 extracts words from the identified segments as words that are highly likely to be related to the specific topic.

Here, the operation of the word extraction unit 36 used in Example 1 will be described separately for different cases depending on the data input. First of all, explanations will be provided regarding a case, in which only those segments of the text under analysis that are associated with segments in the topic-related text are input into the word extraction unit 36. Specifically, what is input is the results of the association process shown in FIG. 13.

Initially, the word extraction unit 36 identifies the segments in the text under analysis that are associated with segments in the topic-related text. In the example of FIG. 13, the word extraction unit 36 identifies segments with IDs=30, 31, 33, and 34. The word extraction unit 36 then extracts words from the text of the segments with IDs=30, 31, 33, and 34.

In addition, at such time, the word extraction unit 36 extracts words based on morphological analysis results. For example, using the segment ID=31 shown in FIG. 13 as an example, 11 types of words are extracted based on the morphological analysis results shown in FIG. 11B. These words are believed to be highly likely to be related to the specific topic. In addition, if the conversation is in English, 12 types of words are extracted based on the morphological analysis results shown in FIG. 20B.

The word extraction unit 36 then outputs the extracted words, but at such time, along with the extracted words, it can also output “topic relevance scores” representing the likelihood that the extracted words are related to the specific topic. It is believed that since the segments identified by the related passage identification unit 31 are the parts that describe the topic information, the higher the frequency, with which the words are found in said parts, the greater the extent to which these words are related to the specific topic. Therefore, suggested examples of the topic relevance scores include scores set for each extracted word such that the scores become higher as the number of the extracted words increases.

Assuming that the topic relevance score is the number of the extracted words of each word, “kinou (noun—may be used as an adverb)” (yesterday; noun) is extracted when the segment ID of the topic-related text is 2 and the segment ID of the text under analysis is 31. Because it is a single group of extracted segments, the topic relevance score is “1”. It should be noted that in the discussion below, such a case is represented as (segment ID of topic-related text, segment ID of text under analysis)=(2,31).

In addition, “hyouji (noun—verbal)” (displayed; verb-past participle) is extracted with (segment ID of topic-related text, segment ID of text under analysis)=(3,33), (3,34). Because there are two groups of extracted segments, the topic relevance score is “2”.

Next, explanations will be provided regarding a case, in which the segments associated with segments in the topic-related text are input into the word extraction unit 36 together with association scores. Specifically, what is input is the results of the association process shown in FIG. 14 with association scores appended thereto.

It should be noted that in this case the word extraction unit 36 identifies segments and extracts words from the identified segments in the same manner as in the example, in which the above-mentioned association scores are not input. In addition, the word extraction unit 36 may output only the extracted words or, alternatively, output topic relevance scores along with the extracted words. Furthermore, the above-described scores set for each extracted word, with the scores becoming higher as the number of the extracted words increases, can also be used as the topic relevance scores in this case.

In addition, for each word, the word extraction unit 36 may determine the sum of the association scores assigned to the segments containing said word and use this sum as a topic relevance score. For example, since “kinou (noun—may be used as an adverb)” (yesterday; noun) is extracted with (segment ID of topic-related text, segment ID of text under analysis)=(2.31), the topic relevance score is 0.6.

Furthermore, since “hyouji (noun—verbal)” (displayed; verb-past participle) is extracted with (segment ID of topic-related text, segment ID of text under analysis)=(3,33), (3,34), the topic relevance score is 1.1 (=0.4+0.7).

In addition, the word extraction unit 36 can determine the maximum value among the association scores assigned to the associated segments containing said word and use the determined maximum value as the topic relevance score for said word. In such a case, the topic relevance score of “kinou (noun—may be used as an adverb)” (yesterday; noun) is “0.6”. In addition, the topic relevance score of “hyouji (noun—verbal)” (displayed; verb-past participle) is 0.7 (=max(0.4,0.7)).

[Step A5]

Subsequently, the statistical model generation unit 33 receives the topic-related text from the input device 10 and receives the extraction results obtained in Step A4 from the latent topic word extraction unit 32. The statistical model generation unit 33 then uses them to generate a statistical model that estimates the extent to which words in the text under analysis occur in the specific topic. At such time, the statistical model generation unit 33 generates the statistical model such that the extent, to which the words in the topic-related text and the words extracted in Step A4 occur in the specific topic, is increased.

Specifically, the statistical model generation unit 33 generates a statistical model, in which the extent of occurrence of the words in the specific topic is given by the following Equation 3.

$$P ( t \vert w ) = \frac{{P}_{topic} ( w ) + {Exist}_{2} ( w )}{1 + {Exist}_{2} ( w )} \qquad [ Eq . 3 ]$$

Here, in the above Equation 3, w designates a word, t designates a specific topic, and P(t|w) is the probability of occurrence of word w in specific topic t. In addition, P_{topic}(w) is a value obtained by normalizing the topic relevance score of word w to the range of from 0 to 1. It should be noted that if no topic relevance scores are supplied to the statistical model generation unit 33 as input, then P_{topic}(w) is 1 when word w occurs in the word list extracted in Step A4 and 0 when it does not occur in it.

Exist₂(w) represents the occurrence of word w in the topic-related text. Specifically, for example, the number of times word w occurred in the topic-related text can be used as Exist₂(w). Further, as another example, a value set to 1 if word w occurred in the topic-related text and to 0 if it did not occur in it can be used as Exist₂(w).

In addition, the normalization of the above-mentioned topic relevance scores can be implemented using the following process. First of all, if there are negative values among the topic relevance scores, a minimum topic relevance score is added to each topic relevance score and all the topic relevance scores are set to values of 0 or more. Then, subsequent to the correction, whereby all the topic relevance scores are set to values of 0 or more, normalization to the range of from 0 to 1 can be implemented by dividing the topic relevance scores by the maximum value of the corrected topic relevance scores.

Accordingly, generating a statistical model, in which the extent of occurrence is given by the above Equation 3, means generating a statistical model that increases the extent to which the words that appear in the word list extracted in Step A4 and the topic-related text occur in the specific topic.

In addition, in Example 1, when generating the statistical model, the statistical model generation unit 33 can also use an existing pre-built statistical model for the specific topic. In other words, the statistical model generation unit 33 can also generate a statistical model for estimating the extent of occurrence of the words of the text under analysis in the specific topic by correcting the extent to which words occur in the specific topic determined in the existing statistical model. A statistical model which, upon input of a word, outputs a probability of occurrence as the extent to which said word occurs in the specific topic, is suggested as an example of such an existing statistical model. Specifically, when such a statistical model is utilized, the statistical model generation unit 33 generates the statistical model by changing the extent of occurrence in the specific topic using Equation 4 below.

$${P}_{new} ( t \vert w ) = \frac{{P}_{old} ( t \vert w ) + {Exist}_{2} ( w ) + {P}_{topic} ( w )}{1 + {Exist}_{2} ( w ) + {P}_{topic} ( w )} \qquad [ Eq . 4 ]$$

Here, in the above Equation 4, the definitions of w, t, Exist₂(w), and P_{topic}(w) are the same as the definitions in the above Equation 3. In addition, P_{old}(t|w) represents the probability of occurrence w of word w in specific topic t, which is defined in the existing statistical model received as input. P_{new}(t|w) designates a corrected probability of occurrence of word w in specific topic t.

In addition, in Example 1, upon input of a word, the existing statistical model may output a score whose value increases for a word that tends to occur more often and decreases for a word that tends to occur less often in the specific topic as the extent to which said word occurs in the specific topic. When such a statistical model is utilized, the statistical model generation unit 33 generates the statistical model by changing the extent of occurrence in the specific topic using Equation 5 below.

Score_{new}(t|w)=Score_{old}(t|w)+a(Exist₂(w)SC_{topic}(w)) [Eq. 5]

Here, in the above Equation 5, the definitions of w, t, Exist₂(w) are the same as the definitions in the above Equation 3. In addition, SC_{topic}(w) is the topic relevance score of word w or a value obtained by normalizing the topic relevance score of word w to the range of from 0 to 1. It should be noted that if no topic relevance scores are supplied to the statistical model generation unit 33 as input, then SC_{topic}(w) is 1 is word w occurred in the word list extracted in Step A4 and 0 did it did not occur in it. In addition, the normalization of the topic relevance scores to the range of from 0 to 1, which is performed in order to obtain SC_{topic}(w), is done using a process similar to the one used for P_{topic}(w), which was explained in the above Equation 3.

In addition, in the above Equation 5, “a” is a real number larger than 0 that is preset manually, based on preliminary experiments, etc. In addition, Score_{old}(t|w) represents the extent of occurrence of word w in specific topic t, which is defined in the existing statistical model and received as input. Score_{new}(t|w) designates a corrected extent of occurrence of word w in specific topic t.

Thus, when the above Equation 4 and Equation 5 are used, a correction is carried out in order to increase the extent of occurrence for the words in the topic-related text and the words extracted in Step A4. Accordingly, in such situations, the statistical model generation unit 3 generates the statistical model such that the extent, to which the words in the topic-related text and the words extracted in Step A4 occur in the specific topic, is increased.

In addition, in Example 1, when generating the statistical model, the statistical model generation unit 33 can also use texts other than the topic-related text to be related to the specific topic, as training data, for the purpose of statistical model training. The operation of the statistical model generation unit 33 in such cases is described below.

First of all, the statistical model generation unit 33 creates new training data by adding two kinds of data to a text other than the topic-related text to be related to the specific topic that is inputted as training data, and uses the new training data to generate a statistical model. A list of data sets made up of the words extracted in Step A4 and values obtained by normalizing the topic relevance scores of said words to the range of from 0 to 1 (henceforth designated as “normalized values”), as well as the topic-related text are suggested as the above-mentioned two kinds of data.

It should be noted that the topic relevance score normalization process can be implemented using the same type of processing as the topic relevance score normalization process used in the determination of P_{topic}(w) in the above Equation 3. In addition, if no topic relevance scores are supplied as input for the statistical model generation unit 33, the normalization value is set to 1.

For example, the statistical model generation unit 33 uses the new training data to determine the probability with which words occur in connection with the specific topic as “probability of occurrence of word w in specific topic=(number of data elements of specific topic in which word w occurred)/(total number of data elements of specific topic)”.

However, as concerns the number of data elements in the “list of data sets made up of words extracted in Step A4 and normalized values of said words”, upon occurrence of word w, it is increased not by “1”, but only by the value obtained by normalizing the topic relevance score of word w.

The statistical model generation unit 33 then uses pairs made up of words w and the probability of occurrence of words w in the topic obtained as described above as a statistical model. In addition to that, the statistical model generation unit 33 can also generate a statistical model by designating, in the new training data, data related to the specific topic as positive examples and data unrelated to said topic as negative examples, and then using a training algorithm such as ME, SVM, and the like.

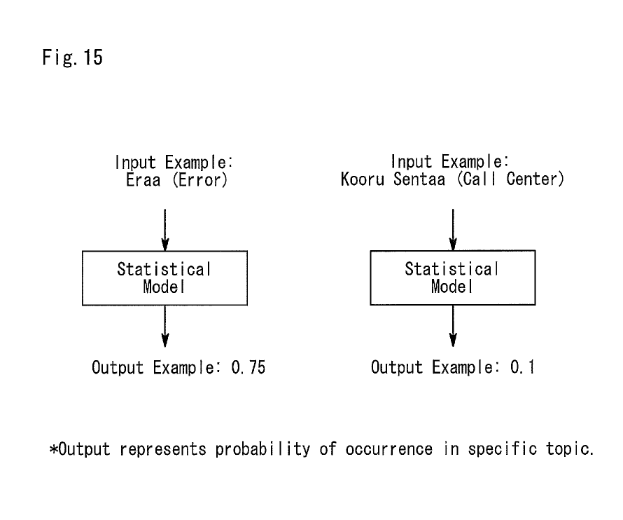

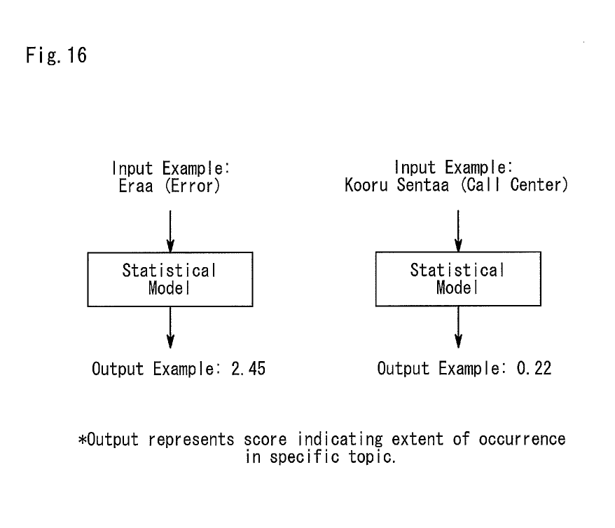

Specifically, based on the data elements in the training data, the statistical model generation unit 33 creates a list of data sets made up of words found in the data and the extent of occurrence of the words in said data and supplies it to the above-described training algorithm. At such time, as far as the extent of occurrence of a word is concerned, the statistical model generation unit 33 may handle cases, in which said word occurred, as “1”, and cases, in which it did not occur, as “0”. Alternatively, it may handle cases, in which it occurred, as “occurrence frequency”, and cases, in which it did not occur, as “0”. As for the number of data elements in the “list of data sets made up of words extracted in Step A4 and normalized values of said words”, a “value obtained by normalizing a topic relevance score (normalized value)” is used in cases, in which said word occurred, and “0” is used in cases, in which it did not occur.

[Step A6] Finally, the statistical model generation unit 33 outputs the statistical model generated in Step A5 to the output device 20. As shown in FIG. 15 or FIG. 16, when words from the text under analysis are input, the statistical model outputs the extent of occurrence of said words for the specific topic. As used herein, the “extent of occurrence” may be a probability that indicates how readily a word tends to occur, which is illustrated in FIG. 15, or it may be a score whose value becomes larger if it tends to occur more readily and becomes smaller if tends to occur less readily, which is illustrated in FIG. 16. FIG. 15 is a diagram illustrating an example of the statistical model obtained in Example 1. FIG. 16 is a diagram illustrating another example of the statistical model obtained in Example 1.

(Effects of Example 1)

The effects of Example 1 are described below. It is generally believed that even when there are similar words in the segments of completely unrelated arbitrarily paired texts, these segments do not necessarily represent the same information and are not necessarily related to identical topics. By contrast, since the text under analysis and the topic-related text in Example 1 describe identical events, parts related to the topic-related text are in most cases present in the text under analysis. It is therefore believed that if word similarity is rather high, information in the segments is related and, at the same time, the topics to which they are related are highly likely to be identical.

Under the above assumption, the association unit 35 then performs the association operation depending on whether word similarity between the segments is high or not. In this case, the segments of the text under analysis associated with the topic-related text are highly likely to be related to the specific topic. Furthermore, as described above, the statistical model generation unit 33 considers the words in the segments of the text under analysis that are associated with the segments of the topic-related text by the association unit 35 as words occurring in connection with the specific topic. The statistical model generation unit 33 then generates the statistical model such that the extent of occurrence of said words in the specific topic is increased.

Consequently, in Example 1, the topic-related words that did not occur in the topic-related text are compensated for in the process of statistical model generation. Accordingly, an increase in the estimation accuracy of the statistical model is achieved even if the parts describing the topic in the text under analysis and the topic-related text are not identical and, furthermore, even if there are differences between the words used.

For example, in Example 1, the word “error” is a word used in the text under analysis (telephone call speech recognition results (Reception ID=311)) in the specific topic (Malfunction Status). However, this word does not occur in the topic-related text (Help Desk memo (acceptance ID=311)). Therefore, in the technology of the above-described Non-patent Documents 1 and 2, in which training was performed based only on words occurring in the topic-related text, it would be extremely difficult to train the word “error” as occurring in the specific topic. In this case, the estimation accuracy of the generated statistical model is degraded.

By contrast, in Example 1, “error” is contained in the segments of the text under analysis (segments ID=33, 34) associated with the segments of the topic-related text. Accordingly, an improvement in the estimation accuracy is achieved because the statistical model is generated such that “error” is considered to be an example of the specific topic and the extent of occurrence of this word in the specific topic is increased.

Further, in Example 1, the word extraction unit 36, which forms part of the latent topic word extraction unit 32, can compute topic relevance scores that indicate the degree in which the extracted words are related to the topic information. As discussed in Embodiment 1, the topic relevance scores are configured such that the higher the degree in which they are related to the specific topic, the higher their value.

For example, the number of the words contained in the segments associated by the related passage identification unit 31 can be used as a topic relevance score. In such a case, as described in Step A4 of Example 1, the topic relevance score of the word hyouji (display) is “2”. On the other hand, the topic relevance score is “1” of the word nanika (any) is “1”. For this reason, the word hyouji (display) is determined to be more related to the topic “malfunction status” than the word nanika “any”. Therefore, the latent topic word extraction unit 32 computes the topic relevance scores and the statistical model generation unit 33 generates the statistical model such that the higher the topic relevance score, the larger the extent of occurrence in the specific topic. This ensures an increase in the estimation accuracy of the statistical model.

Furthermore, in Embodiment 1, the association unit 35, which forms part of the related passage identification unit 31, can compute association scores. As described in Embodiment 1, the association scores indicate the degree of content match between the segments of the text under analysis and the segments of the topic-related text with which association is established, and are configured such that their values increase when the degree of match is higher. Therefore, the higher the association score, the closer the match between the content of the segments of the text under analysis and the segments of the topic-related text with which association is established and, as a result, the higher the likelihood that they contain descriptions related to the specific topic. For this reason, the likelihood of involvement in the specific topic is higher for words contained in passages with higher association scores.

For example, in the example of FIG. 13, the association score of (3,34) (=(segment ID of the topic-related text, segment ID of the text under analysis)) becomes higher than the association score of (3,33) (=same as above). For this reason, it can be seen that the word “XXX” in the text under analysis with a segment ID of 34 is more involved in the topic “Malfunction Status” than the word “?” in the text under analysis with a segment ID of 33. Therefore, the related passage identification unit 31 computes the association scores, the latent topic word extraction unit 32 is configured such that the higher the association score, the higher the topic relevance score, and the statistical model generation unit 33 may indirectly utilize the information in the association scores using the relevance scores. This ensures an increase in the estimation accuracy of the statistical model.

### Example 2

### Operation of Example 2

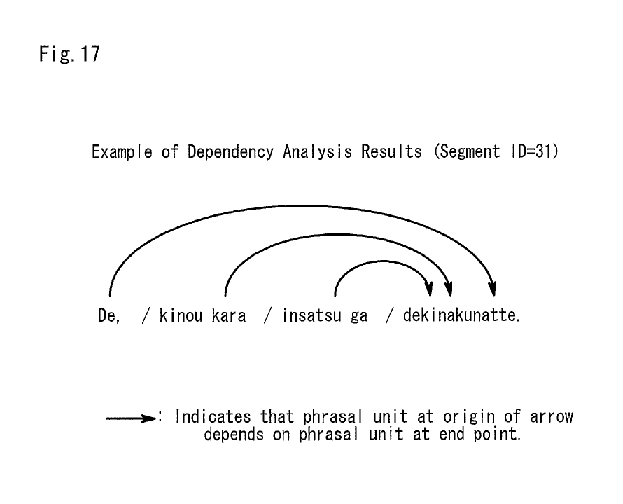

Next, a specific example of the information analysis apparatus and information analysis method of Embodiment 2 will be described with reference to FIG. 17. In addition, in the discussion below, the operation of the information analysis apparatus used in Embodiment 2 is described using the flow chart shown in FIG. 4. In addition, refer to FIG. 3 as appropriate.

In Example 2, the text under analysis is a speech-recognized text obtained by running speech recognition on telephone call speech at a Call Center, which is illustrated in FIG. 7 in the same manner as in Example 1. In addition, as shown in FIG. 8, the topic-related text is text entered in the “Malfunction Status” field in a Help Desk memo prepared based on the conversation recognized in the speech-recognized text shown in FIG. 7. Furthermore, in Example 2, the process of generating a statistical model of the words found in the speech-recognized text (Reception ID=311) shown in FIG. 7, which is used to estimate the extent of occurrence in the topic “Malfunction Status” of the Help Desk memo illustrated in FIG. 8, will be described below in the same manner as in Example 1.

[Step B1-Step B4]

First of all, Steps B1-B4 are executed. Steps B1-B4 in Example 2 are performed in the same manner as Steps A1-A4 in Example 1. However, in Example 2, in Step B4, in addition to outputting the extracted words or the extracted words and their topic relevance scores, the word extraction unit 136 can also output the segment IDs, to which the words belong. In such a case, the output segment IDs are used for processing in the filtering unit 137.

For example, when the input is the example illustrated in FIG. 13, “display 33)” and “display (ID: 34)” are output for the word hyouji (display). In addition, when the input is the example illustrated in FIG. 14, “display (association score: 0.4, ID: 33)” and “display (association score: 0.7 ID: 34)” are output.

[Step B5]

Subsequently, the filtering unit 137 identifies the words that are particularly likely to be related to the specific topic among the words extracted in Step B4 and outputs the identified words. At such time, the filtering unit 137 identifies words corresponding, for example, to any of the above-described items (1)-(6), which were discussed in the above-described Embodiment 2. In other words, the filtering unit 137 performs word identification using the type of the words, the frequency of word occurrence, the position of the words, the distance from the words to the common words, the dependency distance from the phrasal units containing the common words, and combinations thereof as criteria for making a determination. Here, the operation of the filtering unit 137 will be explained for each of the following cases on a case-by-case basis depending on the type of the input data and the type of criteria used for word identification.

[Step B5: Case 1]

First of all, the description will focus on the operation that takes place upon input of words contained in those segments in the text under analysis that are associated with the segments in the topic related text, or said words and the segment IDs to which said words belong, to the filtering unit 137. In this case, no topic relevance scores are input to the filtering unit 137. In addition, in the description that follows, the operation that takes place when 11 types (12 types of words in case of English) of words from the segment ID=31 of the text under analysis are input to the filtering unit 137 will be described as a specific example.

When the filtering unit 137 identifies words that are particularly likely to be associated with the specific topic using part of speech and other word types as criteria, the word types that are particularly likely to correspond to the specific topic are preset and word identification is carried out based on the settings. For example, the independent words identified as particularly likely to be associated with the specific topic in the above-described specific example are “de (so, . . . )”, “kinou (yesterday)”, “insatsu (printing)”, “deki (can)”, and “nat . . . (become)”. In case of English, “And”, “nothing”, “has”, “come”, “printer”, and “yesterday” are identified. In addition, a score indicating the magnitude of the likelihood of being associated with the specific topic depending on the part of speech or word type may be manually configured for each part of speech or word type in advance. In such a case, the filtering unit 137 can identify the pre-configured scores based on the part of speech or word type and output said scores as topic relevance scores.

When the filtering unit 137 identifies words that are particularly likely to be associated with the specific topic using the frequency of word occurrence as a criterion, a threshold value of the occurrence frequency is configured for the input word set. The filtering unit 137 then identifies words whose occurrence frequency is not lower than a threshold value. It should be noted that the configuration of the threshold value can be performed manually based on the results of preliminary experiments conducted in advance. In addition, in such a case, the filtering unit 137 can output the frequency of word occurrence as the topic relevance scores of said words.

In addition, when identifying words that are particularly likely to be associated with the specific topic using word position as a criterion, the filtering unit 137 identifies the common words as a first step. The filtering unit 137 then identifies words located in the phrasal units in which the common words are located (words from the same phrasal units). In such a case, the identified words correspond to words that are highly likely to be related to the specific topic.

As discussed in Embodiment 2, common words are words that are common to the parts identified by the related passage identification unit 131 and to the topic information of the topic-related text. For example, the filtering unit 137 identifies words contained in the parts identified by the related passage identification unit 131 and identifies words with surface base forms and parts of speech matching the identified words among the words indicating the topic information of the topic-related text. This identified words are the common words.

In addition, the filtering unit 137 can use synonym dictionaries or dictionaries of words of similar meaning developed in advance to identify words that are synonymous to, or having meanings similar to, the above-mentioned initially identified words and use words matching the identified words among the words indicating the topic information of the topic-related text as the common words. If we assume that in the above-described specific example the common words are words that match the words obtained from the morphological analysis results in terms of surface and part of speech and, at the same time, are independent words, then “kinou (yesterday)” and “insatsu (printing)” are common words.

Assuming that phrasal unit boundaries are represented by “/” in the specific example, the phrasal unit of the segment ID=31 will be “de(so), /kinou kara (since yesterday)/insatsu ga (printing)/dekinakunatte (has become impossible).” Here, since the common words are “kinou (yesterday)” and “insatsu (printing)”, the words “kinou (yesterday)”, “kara (since)”, “insatsu (printing)”, and “ga (Subject marker)”, which are located in the same phrasal unit as the common words, are identified as the words. In case of English, the phrasal unit is “And,/nothing/has come out of the printer/since yesterday”. Accordingly, because the common words are “yesterday” and “printer”, the words “since”, “yesterday”, “the”, and “printer”, which are located in the same phrasal unit as the common words, are identified.

In addition, in the above-described case, the topic relevance scores of the identified word are configured to increase as they become closes to the common words. The filtering unit 137 can output the topic relevance scores of the identified words along with the words. For example, the topic relevance scores of the common words can be set to “2” and the topic relevance scores of other words can be based on an inverse of the distance from the common words closest to said words.

In addition, when identifying words that are particularly likely to be associated with the specific topic using the distance from the words to the common words as a criterion, in the same manner as in the case of using the position of the words, the filtering unit 137 identifies the common words as a first step. The filtering unit 137 then identifies words whose distance from the common words is not longer than a threshold value. In such a case, the configuration of the threshold value can be performed manually based on the results of preliminary experiments etc. conducted in advance.

In the above-described specific example, it is assumed that the threshold value is set, for instance, to 2. In such a case, the filtering unit 137 identifies “de (And)”, “,”, “kinou (yesterday)”, “kara (since)”, “insatsu (printing)”, “ga (Subject marker)”, and “deki (can)”, which are the two words located respectively on the right and left of “kinou (yesterday)” and “insatsu (printing)”. In case of English, the filtering unit 137 identifies “of”, “the”, “printer”, “since”, “yesterday”, and “.”, which are the two words located respectively to on right and left of “printer” and “yesterday”. In addition, in the above-mentioned case, the topic relevance scores of the identified words may be configured to increase as they become closer to the common words. The filtering unit 137 can output the topic relevance scores of the identified words along with the words. For example, the topic relevance scores of the common words can be set to “2” and the topic relevance scores of other words can be based on an inverse of the distance from the common words closest to said words.

Furthermore, when identifying words that are particularly likely to be associated with the specific topic using the dependency distance from the phrasal unit containing common words as a criterion, in the same manner as when word position is used as a reference, the filtering unit 137 identifies the common words as a first step. The filtering unit 137 then identifies words whose dependency distance from the phrasal unit containing the common words is not longer than a threshold value. In such a case, the configuration of the threshold value can be performed manually based on the results of preliminary experiments etc. conducted in advance.

In addition, in Example 2, the number of dependency relationships traversed when tracing from a certain phrasal unit A to a certain phrasal unit B via dependency relationships is used as the dependency distance between a certain phrasal unit A and a certain phrasal unit B. In the above-described specific example, the dependencies of the segment ID=31 are as shown in FIG. 17. FIG. 17 is a diagram illustrating an example of the results of the dependency analysis performed in Example 2. It should be noted that FIG. 17 illustrates a situation, in which the conversation is conducted in Japanese.

As shown in FIG. 17, in the above-described specific example, the number of the respective dependency relationships between “de (And)” and “dekinakunatte (became impossible)”, between “kinoukara (since yesterday)” and “dekinakunatte (became impossible)”, and between “insatsuga (printing-Subject)” and “dekinakunatte (became impossible)” is “1”. Accordingly, the respective dependency distances are 1. In addition, since in the above-described specific example the common words are “kinou (yesterday)” and “insatsu (print)”, if for example we assume that the threshold value is set to 1, then, as shown in FIG. 17, the phrasal units whose distances from the phrasal units containing “kinou (yesterday)” or “insatsu (print)” are 1 or less, are “kinoukara (since yesterday)”, “insatsuga (printing-Subject)”, and “dekinakunatte (became impossible)”. Accordingly, the filtering unit 137 identifies “kinou (yesterday)”, “kara (since)”, “insatsu (print)”, “ga (Subject marker)”, “deki (can)”, “naku (not)”, “nat (become)”, “te (gerund ending)”, and “.”

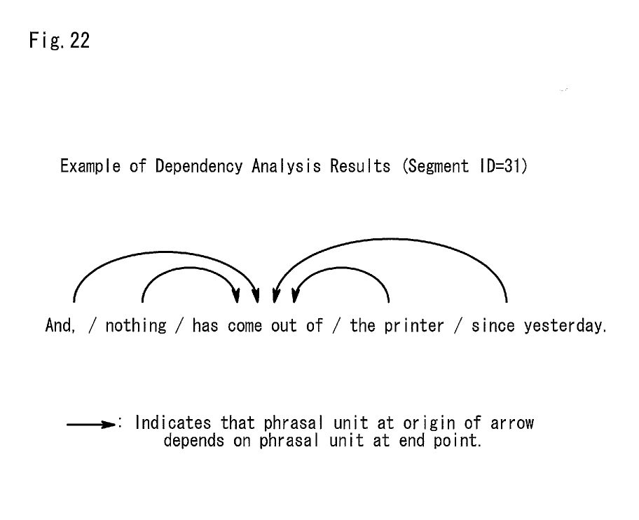

In addition, in case of English, the dependencies of the segment ID=31 are as shown in FIG. 22. FIG. 22 is a diagram illustrating another example of the results of the dependency analysis performed in Example 2. In the example of FIG. 22, the number of the respective dependency relationships between “And,” and “has come out of”, “nothing” and “has come out of”, “the printer” and “has come out of”, “since yesterday” and “has come out of” is “1”. Accordingly, in the example of FIG. 22 the respective dependency distances are also “1”. Furthermore, since the common words are “printer” and “yesterday”, if we assume that the threshold value is set to 1 in this case, too, then the phrasal units whose distances from the phrasal units containing “printer” or “yesterday” are 1 or less, are “has come out of”, “the printer”, and “since yesterday.”. Accordingly, the filtering unit 137 identifies “has”, “come”, “out”, “of”, “the”, “printer”, “since”, “yesterday”, and “.”

In addition, in the above-described example of FIG. 17 and example of FIG. 22, the topic relevance scores of the identified words may be configured to increase as they become closer to the phrasal units containing the common words. The filtering unit 137 can output the topic relevance scores of the identified words along with the words. For example, the topic relevance scores of the common words can be set to “2” and the topic relevance scores of other words can be based on an inverse of the dependency distance from the phrasal units containing the common words closest to the phrasal units, to which said word belong.

In addition, the filtering unit 137 identifies the words that are particularly likely to be related to the specific topic using various combinations of the above-described criteria. In such cases, the filtering unit 137 can, for example, obtain a sum of the topic relevance scores determined by identifying words based on the criteria and output the sum of the topic relevance scores along with the identified words.

Furthermore, if the degree of importance varies depending on the criteria, weights may be assigned in advance such that the value becomes larger as the degree of importance increases. In such case, the filtering unit 137 can use said weights to obtain a weighted sum of the topic relevance scores obtained according to the respective measures. The thus determined sum of the topic relevance scores is output along with the identified words.

Also, in addition to the thus identified word sets and topic relevance scores, the filtering unit 137 can also output words that have not been considered as words particularly likely to be related to the specific topic among the words supplied as input from the word extraction unit 136. At such time, the filtering unit 137 can output the topic relevance scores of said words in addition to the words that have not been considered. It should be noted that the topic relevance scores of the words that have not been considered are set to values that are lower than the minimum value of the topic relevance scores of the words considered to be particularly likely to be related to the specific topic by the filtering unit 137.

[Step B5: Case 2]

Next, the description will focus on the operation that takes place upon input of the topic relevance scores computed by the word extraction unit 136 in addition to the words contained in those segments in the text under analysis that are associated with the segments in the topic related text by the filtering unit 137, or said words and the segment IDs to which said words belong.

First of all, the filtering unit 137 calculates the topic relevance scores for the words input from the word extraction unit 136 by operating in the same manner as when the above-mentioned topic relevance scores are not input (Step B5: Case 1). The topic relevance scores in this case are designated as “the first topic relevance scores”.

The filtering unit 137 then obtains a product of the first topic relevance scores and the topic relevance scores of the words input together with the words from the word extraction unit 136 and designates it as “the second topic relevance scores”. Subsequently, the filtering unit 137 identifies words, whose second topic relevance scores, as obtained above, are not lower than a predetermined threshold value, as words particularly likely to be associated with the specific topic.

After that, the filtering unit 137 outputs either only the identified word set, or the identified words set together with the second topic relevance scores of the words of said word set. Also, in addition to the identified word set and the second topic relevance scores of the words of said word set, the filtering unit 137 can output information identifying words whose second topic relevance scores are not higher than the threshold value. At such time, the filtering unit 137 can output the words whose second topic relevance scores are not higher than the threshold value along with their second topic relevance scores.

[Step B6-Step B7]

Step B6 is executed by the statistical model generation unit 133 subsequent to the execution of Step B5. As a result, the statistical model is generated, in which the extent of occurrence of the words identified by the filtering unit 137 is increased. Then, after executing Step B6, the statistical model generation unit 133 executes Step B7. Steps B6 and B7 in Example 2 are performed in the same manner as Steps A5 and A6 in Example 1.

(Effects of Example 2)

The effects of Example 2 are described below. In Example 2, unlike Example 1, words that are particularly likely to be related to the specific topic are identified by the filtering unit 137 among the words in the segments of the text under analysis that are associated with the segments of the topic-related text. In addition, in Example 2, the statistical model is generated such that the extent of occurrence of the words identified by the filtering unit 137 is increased.

For this reason, in accordance with Example 2, the extent of occurrence of words having little relation to the specific topic in the specific topic is prevented from becoming erroneously high, and, as a result, the estimation accuracy of the statistical model is further improved in comparison with Example 1.

For instance, in the above-described specific example, the filtering unit 137 employs criteria such as information on word types and on whether the words are located in phrasal units containing common words, as well as their dependency distance from phrasal units containing common words as word identification criteria. Accordingly, since the filtering unit 137 identifies words using the adopted criteria, words that bear little relation to the specific topic, such as “de (And)” and “,” in segment ID=31 in the text under analysis, are eliminated from identification. Accordingly, the effects of these words on the generation of the statistical model are alleviated and, as a result, it becomes possible to generate a statistical model of high estimation accuracy.

### Example 3

### Operation of Example 3

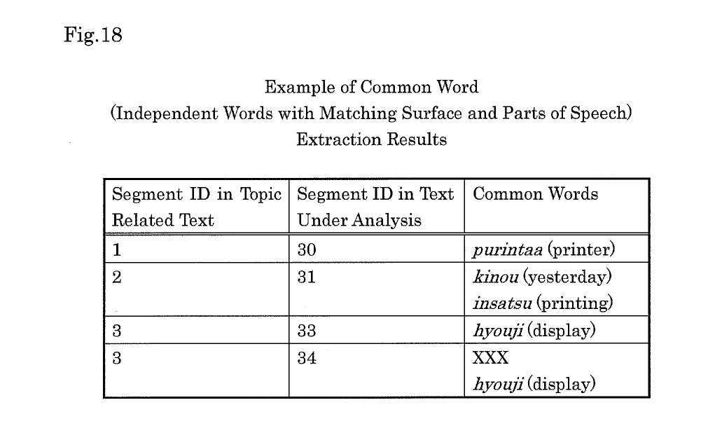

Next, a specific example of the information analysis apparatus and information analysis method of Embodiment 3 will be described with reference to FIG. 18. In addition, in the discussion below, the operation of the information analysis apparatus used in Embodiment 3 is described using the flow chart shown in FIG. 6. In addition, refer to FIG. 5 as appropriate.

In Example 3, the text under analysis is a speech-recognized text obtained by running speech recognition on telephone call speech at a Call Center, which is illustrated in FIG. 7 in the same manner as in Example 1. In addition, as shown in FIG. 8, the topic-related text is text entered in the “Malfunction Status” field in a Help Desk memo prepared based on the conversation recognized in the speech-recognized text shown in FIG. 7. Furthermore, in Example 3, the process of generating a statistical model of the words found in the speech-recognized text (Reception ID=311) shown in FIG. 7, which is used to estimate the extent of occurrence in the topic “Malfunction Status” of the Help Desk memo illustrated in FIG. 8, will be described below in the same manner as in Example 1.

[Step C1-Step C4]

First of all, Steps C1-C4 are executed. Steps C1-C4 in Example 3 are performed in the same manner as Steps A1-A4 in Example 1.

[Step C5]

The common word extraction unit 237 executes Step C5 simultaneously with Step C4 or subsequent to Step C4. Specifically, first of all, the common word extraction unit 237 receives the results of association of the text under analysis with the topic-related text obtained by analysis in Step C3. The common word extraction unit 237 then extracts the words that have been used in the parts related to the specific topic in the text under analysis from the words contained in the topic-related text.

Specifically, the common word extraction unit 237 extracts shared words (common words) and words of the associated segments of the text under analysis contained among the words in the topic-related text. The definition of the “common words”, as used in Example 3, has the same meaning as the definition of common words identified in Step B5 of Example 2. Here, the operation of the common word extraction unit 237 will be explained for each of the following cases on a case-by-case basis depending on the type of the input data.

[Step C5: Case 1]

First of all, explanations will be provided regarding operation that takes place when only the segments associated with the segments of the topic-related text are input into the word extraction unit 237, without inputting association scores. For example, if the input is as shown in the example illustrated in FIG. 13, the common word extraction unit 237 extracts the words contained in the associated segments of the text under analysis and words matching in terms of surface base forms and parts of speech among the words contained in the segments of the topic-related text, as common words. Accordingly, the results illustrated in FIG. 18 are obtained. FIG. 18 is a diagram illustrating an example of the common words extracted in Example 3.

The common word extraction unit 237 then outputs the common words illustrated in FIG. 18. Also, in addition to the extracted common words, the common word extraction unit 237 can output “likelihood-of-use scores”, which indicate the likelihood of their being used in the parts related to the specific topic in the text under analysis.

As discussed in Embodiment 3, the likelihood-of-use scores are configured such that the higher the likelihood of being used in parts related to the specific topic in the text under analysis, the higher their value. Specifically, the common word extraction unit 237 can use the number of extracted words as likelihood-of-use scores. In such a case, the word “purintaa (printer)” is extracted in (segment ID of topic-related text, segment ID of text under analysis)=(1,30). Accordingly, the likelihood-of-use score is “1”. In addition, the word “hyouji (display)” is extracted in (segment ID of topic-related text, segment ID of text under analysis)=(3,33) and (3,34). Accordingly, the likelihood-of-use score is “2”.

[Step C5: Case 2]

Next, explanations will be provided regarding operation in a case, in which association scores are input into the word extraction unit 237 along with the segments associated with the segments of the topic-related text. In this case, the common word extraction unit 237 extracts the common words in the same manner as when no association score are input. In addition, in such a case, the common word extraction unit 237 may output only the extracted common words or, alternatively, can output the likelihood-of-use scores of the common words along with the extracted common words.

If, for instance, the common words are contained in multiple segment sets, the common word extraction unit 237 can obtain association scores for the common words in each set, sum them up, and configure the resultant sum as a likelihood-of-use score. A case, in which the example illustrated in FIG. 14 is input to the common word extraction unit 237, will be described below. Since the word “purintaa (printer)” is extracted in (segment ID of topic-related text, segment ID of text under analysis)=(1,30), i.e. in only one segment set, the likelihood-of-use score is “0.7”. On the other hand, the word “hyouji (display)” is extracted in (segment ID of topic-related text, segment ID of text under analysis)=(3,33) and (3,34), i.e. two segments. Accordingly, the topic relevance score is “1.1” (=0.4+0.7).

In addition, if the common words are contained in multiple segment sets, the common word extraction unit 237 can compare the association scores assigned to the common words in each set, obtain the maximum association score, and configure it as a likelihood-of-use score. A case, in which the example illustrated in FIG. 14 is input to the common word extraction unit 237, will be described below. In such a case, “purintaa (printer)” is extracted in only one segment set and the likelihood-of-use score is “0.7”. On the other hand, “hyouji (display)” is extracted in two segment sets. Also, in one segment set the association score is 0.4, and in the other segment set the association score is 0.7. Accordingly, the likelihood-of-use score is “0.7” (=max (0.4, 0.7)).

[Step C6]

Subsequent to Steps C4 and C5, the statistical model generation unit 233 receives the topic-related text from the input device 210 and receives the word extraction results obtained in Step C4 from the latent topic word extraction unit 232. In Example 3, unlike Examples 1 and 2, the statistical model generation unit 233 also receives the common word extraction results obtained in Step C5 from the common word extraction unit 237. The statistical model generation unit 233 then uses these results to generate a statistical model that estimates the extent to which words in the text under analysis occur in the specific topic.

In addition, in such a case, the statistical model generation unit 233 generates the statistical model such that the extent of occurrence of the words extracted in Step C4 in the specific topic is increased. In addition, the statistical model generation unit 233 generates the statistical model such that the extent of occurrence of the common words extracted in Step C5 is made larger than the extent of occurrence of words other than said common words in the topic-related text.

The operation of the statistical model generation unit 233 in Example 3 will be described below. Specifically, the statistical model generation unit 233 generates a statistical model, in which the extent of occurrence of the words in the specific topic is given by the following Equation 6.

$$P ( t \vert w ) = \frac{{P}_{topic} ( w ) + {P}_{common} ( w ) + {Exist}_{2} ( w )}{2 + {Exist}_{2} ( w )} \qquad [ Eq . 6 ]$$

Here, in the above Equation 6, the definitions of w, t, P(t|w), and P_{topic}(w), and Exist₂(w) are the same as the definitions in the above Equation 3. In addition, in the above Equation 6, P_{common}(w) is a value obtained by normalizing the likelihood-of-use score of common word w to the range of from 0 to 1 if word w is a common word extracted in Step C5, and 0 if word w is not the above-mentioned common word. It should be noted that if no topic relevance scores are supplied to the statistical model generation unit 233 as input, then P_{common}(W) is 1 if word w is a common word extracted in Step C5 and 0 if word w is not the above-mentioned common word. In addition, the normalization of the likelihood-of-use scores to the range of from 0 to 1 is performed using a process similar to the one used for normalizing topic relevance scores.

Accordingly, the statistical model is generated using P_{topic}(w) and Exist₂(w) in the above Equation 6 such that the extent, to which the words in the topic-related text and the words in the word list extracted in Step C4 occur in the specific topic, is increased. In addition, the statistical model is generated using P_{common}(w) in the above Equation 6 such that the extent of occurrence of the common words extracted in Step C5 is made larger than the extent of occurrence of words other than said common words in the topic-related text.

In addition, in Example 3, in the same manner as in Example 1, when generating the statistical model, the statistical model generation unit 233 can use existing pre-built statistical models for the specific topic. In such a case, the statistical model generation unit 233 generates a statistical model for estimating the extent of occurrence of the words of the text under analysis in the specific topic by correcting the extent to which words occur in the specific topic determined in the existing statistical model. A statistical model which, upon input of a word, outputs a probability of occurrence as the extent to which said word occurs in the specific topic, is suggested as an example of such an existing statistical model. Specifically, when such a statistical model is employed, the statistical model generation unit 233 generates the statistical model by changing the extent of occurrence in the specific topic using, for instance, the following Equation 7.

$${P}_{new} ( t \vert w ) = \frac{{P}_{old} ( t \vert w ) + {P}_{topic} ( w ) + {P}_{common} ( w ) + {Exist}_{2} ( w )}{1 + {P}_{topic} ( w ) + {P}_{common} ( w ) + {Exist}_{2} ( w )} \qquad [ Eq . 7 ]$$

Here, in the above Equation 7, the definitions of w, t, P_{topic}(w), and Exist₂(w) are the same as the definitions in the above Equation 3. The definition of P_{common}(w) is the same as the definition in the above Equation 6. In addition, the definitions of P_{new}(t|w) and P_{old}(t|w) are the same as the definitions in the above Equation 4.

In addition, in Example 3, in the same manner as in Example 1, upon input of a word, the existing statistical model may output a score whose value becomes higher for a word that tends to occur more often and becomes lower for a word that tends to occur less often in the specific topic as the extent to which said word occurs in the specific topic. When such a statistical model is employed, the statistical model generation unit 233 generates the statistical model by changing the extent of occurrence in the specific topic using the following Equation 8.

Score_{new}(t|w)=Score_{old}(t|w)+a(SC_{topic}(w)+SC_{common}(w)+Exist₂(w)) [Eq. 8]

Here, in the above Equation 8, the definitions of w, t, and Exist₂(w) are the same as the definitions in the above Equation 3. In addition, the definitions of “a”, SC_{topic}(w), Score_{old}(t|w), and Score_{new}(t|w) are the same as the definitions in the above Equation 5.

In addition, SC_{common} is the likelihood-of-use score of common word w or a value obtained by normalizing the likelihood-of-use score of common word w to the range of from 0 to 1 if word w is a common word extracted in Step C5, and 0 if word w is not a common word. It should be noted that if no likelihood-of-use scores are supplied to the statistical model generation unit 233 as input, then SC_{common} is 1 if word w is a common word extracted in Step C5 and 0 if word w is not a common word. In addition, the normalization of the likelihood-of-use scores to the range of from 0 to 1 is also performed using a process similar to the process used for normalizing topic relevance scores, as described in the above Equation 3.

In this manner, when the above Equation 7 and Equation 8 are used, the statistical model is generated in the same manner as when using the above Equation 6 such that the extent, to which the words in the topic-related text and the words in the word list extracted in Step C4 occur in the specific topic, is increased. Furthermore, in the generated statistical model, the extent of occurrence of the common words extracted in Step C5 is made larger than the extent of occurrence of words other than the common words in the topic-related text.

In addition, in Example 3, in the same manner as in Example 1, when generating the statistical model, the statistical model generation unit 233 can use texts other than the topic-related text for the specific topic as training data for training the statistical model. The operation of the statistical model generation unit 233 in such cases is described below.

First of all, the statistical model generation unit 233, for every word extracted in Step C4, normalizes the topic relevance score of said word to the range of from 0 to 1 and calculates its value (hereinafter referred to as “normalized value”). This topic relevance score normalization process can be implemented using the same type of processing as the topic relevance score normalization process used in the determination of P_{topic}(w) in the above Equation 3. It should be noted that if no topic relevance scores are supplied as input to the statistical model generation unit 233, the normalization value is set to 1.

The statistical model generation unit 233 then uses, as a type of training data, a list of data sets made up of words extracted in Step C4 and normalized values obtained by normalizing the topic relevance scores of said words to the range of from 0 to 1.

In addition, the statistical model generation unit 233 assigns weights to the words in the topic-related text based on the determination results of Step C5. In such a case, the weights used for the common words extracted in Step 5 are configured to be larger than the weights used for words other than the common words.

For example, the statistical model generation unit 233 sets the weights of the common words extracted in Step C5 to “values obtained by normalizing of likelihood-of-use scores of said words to the range of from 0 to 1 and adding 1 to the resultant values”. On the other hand, the statistical model generation unit 233 sets the weights of the words other than the common words to “1”. It should be noted that the process of normalization of likelihood-of-use scores in this case is performed using a process similar to the process used for topic relevance score normalization in the case of obtaining P_{topic}(w) as described above. In addition, if no likelihood-of-use scores are supplied as input to the statistical model generation unit 233, the weights of the common words extracted in Step C5 are uniformly set to 2.

Then, if the weights are configured for the words as described above, the statistical model generation unit 233 uses the topic-related text having words with configured weights as a type of training data.

In this manner, in Example 3, the statistical model generation unit 233 generates a statistical model using two kinds of new training data as text other than the topic-related text on the specific topic that is input as training data. The new training data is represented by two types of data elements including, firstly, a list of data sets made up of the words extracted in Step C4 and the normalized values of said words, and the topic-related text having words with configured weights.

For example, the statistical model generation unit 233 uses the new training data to determine the probability with which words occur in connection with the specific topic as “probability of occurrence of word w in specific topic=number of data elements of specific topic in which word w occurred/total number of data elements of specific topic”.

However, as concerns the number of data elements in the “list of data sets made up of words extracted in Step C4 and normalized values of said words”, upon occurrence of word w, it is increased not by “1”, but only by the value obtained by normalizing the topic relevance score of word w. In addition, as concerns the number of data elements in the “topic-related text having words with configured weights”, upon occurrence of word w, it is increased not by “1”, but only by the value of the weight assigned to word w.

The statistical model generation unit 233 then uses pairs made up of words w and the probability of occurrence of words w in the topic obtained as described above as a statistical model. In addition to that, the statistical model generation unit 233 can also generate a statistical model by designating, in the new training data, data related to the specific topic as positive examples and data unrelated to said topic as negative examples, and then using a training algorithm such as ME, SVM, and the like.

Specifically, the statistical model generation unit 233 creates a list of data sets made up of words in the data and the extent of occurrence of the words in said data from the data elements in the training data and inputs it to the above-mentioned training algorithm. At such time, as far as the extent of occurrence of words is concerned, the statistical model generation unit 233 may handle cases, in which said words occurred, as “1”, and cases, in which they did not occur, as “0”. Alternatively, it may handle cases, in which it occurred, as “occurrence frequency”, and cases, in which it did not occur, as “0”.

However, as for the number of data elements in the “list of data sets made up of words extracted in Step C4 and normalized values of said words”, “values obtained by normalizing topic relevance scores (normalized values)” are used in cases, in which said words occurred, and “0” is used in cases, in which they did not occur. In addition, as concerns the number of data elements in the “topic-related text having words with configured weights”, upon occurrence of said words, it is handled as “word weight” and if they did not occur, as “0”.

[Step C7] Subsequent to the execution of Step C6, the statistical model generation unit 233 executes Step C7. Step C7 in Example 3 is performed in the same manner as Step A6 in Example 1.

(Effects of Example 3)

In Example 3, unlike Examples 1 and 2, the statistical model generation unit 233 generates the statistical model such that the extent of occurrence of the common words extracted by the common word extraction unit 237 in the specific topic is made larger than the extent of occurrence of words other than the common words in the topic-related text. For this reason, Example 3 mitigates the negative impact on the statistical model exerted by words used in parts that are actually unrelated to the specific topic in the text under analysis. Thus, Example 3 ensures an increase in the estimation accuracy of the statistical model.

For example, let us assume that the text under analysis is the result of telephone speech recognition (Reception ID=311) illustrated in FIG. 9 and the specific topic is “Support Related Requests” in the Help Desk memo. In addition, let us assume that the topic-related text is recorded in the part “Support Related Requests” of the Help Desk memo (Reception ID=311). In such a case, if the extent of occurrence of all the words of the topic-related text in the specific topic is increased, the extent of occurrence of the word “check” in the specific topic “Support Related Requests” will increase. However, in the text under analysis, the word “check” occurs in the topic “Solutions Offered During Call” of the Help Desk memo, but does not occur in the topic “Support Related Requests”. Accordingly, the statistical model needs to be generated, in which the extent of occurrence of the word “confirmation” in the topic “Support Related Requests” is decreased.

By contrast, in Example 3, the statistical model is generated such that the extent of occurrence of the word “check” in the topic “Support Related Requests” does not increase. In other words, in Example 3, words among the words of the topic-related text that are contained in parts describing the specific topic of the text under analysis are identified as common words. Then, the extent to which words other than the common words in the topic-related text occur in the specific topic is precluded from increasing.

In other words, the word “check” is determined to be not included in the parts describing the topic “Support Related Requests” in the text under analysis and the extent of occurrence of the word “check” in the topic “Support Related Requests” is precluded from increasing. Therefore, Example 3 ensures a further increase in the estimation accuracy of the statistical model and makes it possible to generate an appropriate statistical model by analyzing the text under analysis.

In addition, in Example 3, the common word extraction unit 237 can compute “likelihood-of-use scores”, which indicate the likelihood of the extracted common words being used in the parts of the text under analysis that are related to the specific topic. The likelihood-of-use scores are configured such that the higher the likelihood, the higher their values.

For example, when the likelihood-of-use scores are represented by the number of the common words extracted by the common word extraction unit 237, the likelihood-of-use score of the word “hyouji (display)” is “2”, as described in Step C5 of Example 3. On the other hand, the likelihood-of-use score of the word “purintaa (printer)” is “1”. For this reason, the likelihood-of-use score of the word “hyouji (display)”, which occurs to a large extent in the topic “Malfunction Status” of the text under analysis, becomes larger than the likelihood-of-use score of the word “purintaa (printer)”. Therefore, the common word extraction unit 237 computes the likelihood-of-use scores and the statistical model generation unit 233 generates the statistical model such that the higher the likelihood-of-use score, the larger the extent of occurrence in the specific topic. As a result, the generation of an appropriate statistical model is made possible by analyzing the text under analysis.

In addition, in Embodiment 3, the association unit 235, which forms part of the related passage identification unit 231, can compute association scores and can then compute likelihood-of-use scores using said association scores. The association scores indicate the degree of content match between the segments of the text under analysis and the segments of the topic-related text with which association is established, and their values increase when the degree of match is higher. Therefore, the higher the association score, the closer the content match between the segments of the text under analysis and the segments of the topic-related text with which association is established, and the higher the likelihood that they describe the specific topic. For this reason, the likelihood of involvement in the specific topic becomes higher for words contained in passages with higher association scores. Therefore, it is preferable to compute the likelihood-of-use scores such that their value becomes higher for words with higher association scores. As a result, the likelihood-of-use scores are suitable as scores representing the likelihood of being used in the parts related to the specific topic in the text under analysis.

It should be noted that in Example 2 the processing of Step C5 can be performed in parallel to the processing of Step B4 and Step B5, and, furthermore, in Step B6, the results of Step C5 can be used as input and processing similar to that of Step C6 can be carried out. In this case, the effects of Example 3 are obtained in Example 2.

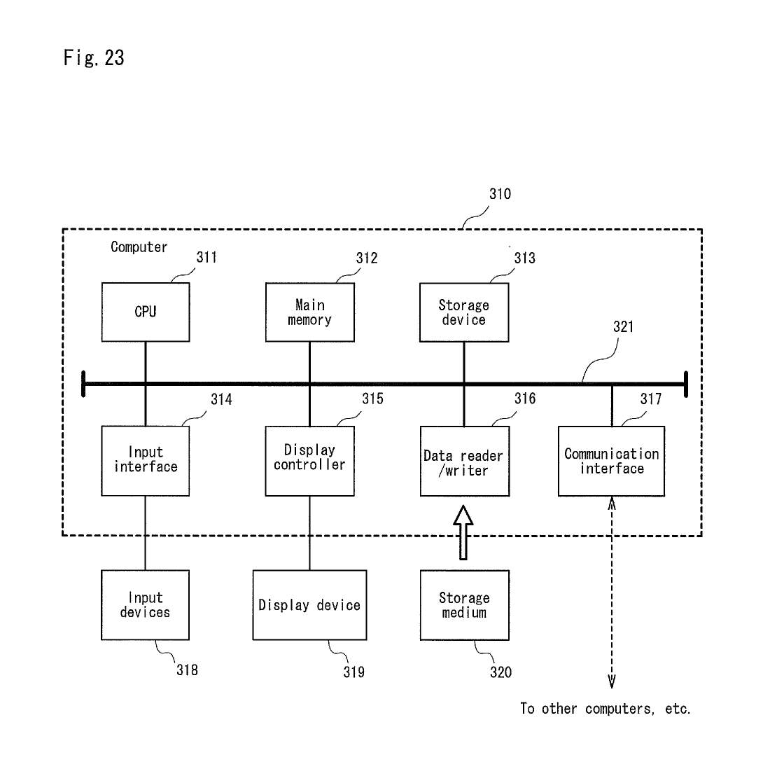

Here, a computer that implements the information analysis apparatus by running the software programs used in the above-described embodiments and examples will be described with reference to FIG. 23. FIG. 23 is a block diagram illustrating a computer capable of running the software programs used in the embodiments and examples of the present invention.

As shown in FIG. 23, the computer 310 comprises a CPU 311, a main memory 312, a storage device 313, an input interface 314, a display controller 315, a data reader/writer 316, and a communication interface 317. These components are interconnected through a bus 321 so as to permit mutual communication of data.

The CPU 311 loads the software programs (code), which are stored in the storage device 313, in the main memory 312 and performs various operations by executing them in a predetermined order. The main memory 312 is typically a volatile storage device, such as a DRAM (Dynamic Random Access Memory), and the like. In addition, the software programs are supplied stored on a computer-readable storage medium 320. It should be noted that the software programs may be distributed via the Internet connected through the communication interface 317.

In addition to hard disk drives, semiconductor storage devices such as flash memory etc. are suggested as specific examples of the storage device 313. The input interface 314 mediates the transmission of data between the CPU 311 and input devices 318, such as a keyboard or a mouse. The display controller 315 is connected to a display device 319 and controls the display of the display device 319.

The data reader/writer 316, which mediates the transmission of data between the CPU 311 and the storage medium 320, reads the software programs from the storage medium 320 and writes the results of the processing to the storage medium 320. The communication interface 317 mediates the transmission of data between the CPU 311 and other computers.

In addition, general-purpose semiconductor storage devices such as CF (Compact Flash) and SD (Secure Digital), etc., as well as magnetic storage media such as floppy disks (Flexible Disk) or optical storage media such as CD-ROMs (Compact Disk Read Only Memory) etc. are suggested as specific examples of the storage medium 320.

While the invention of the present application has been described above with reference to embodiments and examples, the invention of the present application is not limited to the above-described embodiments and examples. It will be understood by those of ordinary skill in the art that various changes in the form and details of the invention of the present application may be made within the scope of the invention of the present application.

This application claims the benefit of priority based on Japanese Patent Application 2009-152758 filed on Jun. 26, 2009, the disclosure of which is incorporated herein in its entirety.

The information analysis apparatus, information analysis method, and computer-readable storage medium used in the invention of the present application have the following features.

(1) An information analysis apparatus generating a topic-related statistical model of words contained in a first text to be analyzed, comprising:

a related passage identification unit that compares a second text, which describes events identical to those of the first text and contains information related to a specific topic, with the first text, and identifies the parts in the first text that are related to the information of the second text,

a latent topic word extraction unit that extracts the words contained in the parts identified by the related passage identification unit, and

a statistical model generation unit that generates a statistical model estimating the extent to which the words contained in the first text occur in the specific topic,

wherein the statistical model generation unit generates the statistical model in such a manner that the extent, to which words contained in the second text and the words extracted by the latent topic word extraction unit occur in the specific topic, is made larger than the extent of occurrence of other words.

(2) The information analysis apparatus according to (1) above, wherein the related passage identification unit divides the first text and the second text into segments respectively serving as set processing units;

compares the first text with the second text on a segment-by-segment basis and associates the segments of the first text with the segments of the second text based on word vector-based similarity between the segments; and

identifies the associated segments of the first text as the parts related to the information of the second text in the first text.

(3) The information analysis apparatus according to claim 2, wherein the related passage identification unit, in the process of the association, associates at least one segment of the first text with each segment of the second text.
(4) The information analysis apparatus according to claim 2,

wherein the related passage identification unit carries out the division into segments on a sentence-by-sentence or paragraph-by-paragraph basis, and

furthermore, when the first text and the second text describe contents of a conversation between a plurality of people, carries out the division into segments on a sentence-, paragraph-, utterance, or speaker basis.

(5) The information analysis apparatus according to (1) above, wherein
the latent topic word extraction unit identifies

words of predetermined types,

words whose frequency of occurrence is not lower than a preset threshold value,

words located in phrasal units that have located therein common words occurring in a common meaning in the parts identified by the related passage identification unit and the information of the second text, to which they are related,

words whose distance from the common words is not greater than a predetermined threshold value,

words located in phrasal units whose dependency distance from the phrasal units containing the common words is not greater than a predetermined threshold value, or

words corresponding to two or more of these words from the words contained in the parts identified by the related passage identification unit, and

extracts the identifies words.

(6) The information analysis apparatus according to (1) above,

wherein the latent topic word extraction unit further computes topic relevance scores that indicate the degree to which the extracted words are related to the information of the second text and, at the same time, rise in value as the degree of relatedness increases, and

the statistical model generation unit generates the statistical model such that the higher the values of the corresponding topic relevance scores, the larger the extent of occurrence of the extracted words.

(7) The information analysis apparatus according to (6) above,

wherein the related passage identification unit further computes association scores that indicate the degree of content match between the identified parts and the information of the second text, to which they are related, and, at the same time, rise in value as the degree of match increases, and

the latent topic word extraction unit computes the topic relevance scores such that for words present in parts with higher association scores the topic relevance scores of the extracted words are made higher.

(8) The information analysis apparatus according to (1) above, further comprising a common word extraction unit that extracts common words occurring in a common meaning from the parts identified by the related passage identification unit and the information of the second text,

wherein the statistical model generation unit further generates the statistical model such that the extents of occurrence of the respective common words extracted by the common word extraction unit are made larger than the extent of occurrence of words contained in the second text that are not the common words.

(9) The information analysis apparatus according to (8) above,

wherein the common word extraction unit further computes likelihood-of-use scores that indicate the likelihood that the extracted common words are used in parts related to the specific topic in the first text and, at the same time, rise in value as the likelihood of use increases, and

the statistical model generation unit generates the statistical model such that the higher the values of the corresponding likelihood-of-use scores, the larger the extent of occurrence of the extracted common words.

(10) The information analysis apparatus according to (9) above,

wherein the related passage identification unit further computes association scores that indicate the degree of content match between the identified parts and the information of the second text, to which they are related, and, at the same time, rise in value as the degree of match increases, and

the common word extraction unit computes the likelihood-of-use scores such that, for words present in parts with higher association scores, the likelihood-of-use scores of the extracted common words are made higher.

(11) An information analysis method used for generating a topic-related statistical model of words contained in a first text to be analyzed, the method comprising the steps of:

(a) comparing a second text, which describes events identical to those of the first text and contains information related to a specific topic, with the first text, and identifying the parts in the first text that are related to the information of the second text;

(b) extracting the words contained in the parts identified in Step (a), and

(c) generating a statistical model estimating the extent, to which words contained in the first text occur in the specific topic, and, at such time, ensuring that the extent, to which the words contained in the second text and the words extracted in Step (b) occur in the specific topic, is made larger than the extent of occurrence of other words.

(12) The information analysis method according to (11) above,

wherein in Step (a),

the first text and the second text are divided into segments respectively serving as set processing units;

the first text and the second text are compared on a segment-by-segment basis and the segments of the first text are associated with the segments of the second text based on word vector-based similarity between the segments; and

the associated segments of the first text are identified as the parts related to the information of the second text in the first text.

(13) The information analysis method according to (12) above,

wherein, in Step (a), in the process of association, at least one of the segments of the first text is associated with each segment of the second text.

(14) The information analysis method according to (12) above,

wherein in Step (a), the division into segments is carried out on a sentence-by-sentence or paragraph-by-paragraph basis, and

furthermore, when the first text and the second text describe contents of a conversation between a plurality of people, the division into segments is carried out on a sentence-, paragraph-, utterance, or speaker basis.

(15) The information analysis method according to (11) above,

wherein, in Step (b),

words of predetermined types,

words whose frequency of occurrence is not lower than a preset threshold value,

words located in phrasal units that have located therein common words occurring in a common meaning in the parts identified in Step (a) and the information of the second text, to which they are related,

words whose distance from the common words is not greater than a predetermined threshold value,

words located in phrasal units whose dependency distance from the phrasal units containing the common words is not greater than a predetermined threshold value, or

words corresponding to two or more of these words are identified among the words contained in the parts identified in Step (a), and

the identified words are extracted.

(16) The information analysis method according to (11) above,

wherein in Step (b), furthermore, topic relevance scores are computed that indicate the degree to which the extracted words are related to the information of the second text and, at the same time, rise in value as the degree of relatedness increases, and

in Step (c), the statistical model is generated such that the higher the values of the corresponding topic relevance scores, the larger the extent of occurrence of the extracted words.

(17) The information analysis method according to (16) above,

wherein in Step (a), furthermore, association scores are computed that indicate the degree of content match between the identified parts and the information of the second text, to which they are related, and, at the same time, rise in value as the degree of match increases, and

in Step (b), the topic relevance scores are computed such that, for words present in parts with higher association scores, the topic relevance scores of the extracted words are made higher.

(18) The information analysis method according to (11) above, further comprising the step of:

(d) extracting common words occurring in a common meaning from the parts identified in Step (a) and the information of the second text,

wherein furthermore, in Step (c), the statistical model is generated such that the extents of occurrence of the respective common words extracted in Step (d) are made larger than the extent of occurrence of words contained in the second text that are not the above-mentioned common words.

(19) The information analysis method according to (18) above,

wherein in Step (d), furthermore, likelihood-of-use scores are computed that indicate the likelihood that the extracted common words are used in parts related to the specific topic in the first text and, at the same time, rise in value as the likelihood of use increases, and

in Step (c), the statistical model is generated such that the higher the values of the corresponding likelihood-of-use scores, the larger the extent of occurrence of the extracted common words.

(20) The information analysis method according to (19) above,

wherein in Step (a), furthermore, association scores are computed that indicate the degree of content match between the identified parts and the information of the second text, to which they are related, and, at the same time, rise in value as the degree of match increases, and

in Step (d), the likelihood-of-use scores are computed such that, for words present in parts with higher association scores, the likelihood-of-use scores of the extracted common words are made higher.

(21) A computer-readable storage medium having recorded thereon a software program for generating, on a computer, a topic-related statistical model of words contained in a first text to be analyzed, the program comprising instructions directing the computer to execute the steps of:

(a) comparing a second text, which describes events identical to those of the first text and contains information related to a specific topic, with the first text, and identifying the parts in the first text that are related to the information of the second text;

(b) extracting the words contained in the parts identified in Step (a), and

(c) generating a statistical model estimating the extent to which words contained in the first text occur in the specific topic, and, at such time, ensuring that the extent, to which the words contained in the second text and the words extracted in Step (b) occur in the specific topic, is made larger than the extent of occurrence of other words.

(22) The computer-readable storage medium according to (21) above,

wherein in Step (a),

the first text and the second text are divided into segments respectively serving as set processing units;

the first text and the second text are compared on a segment-by-segment basis and the segments of the first text are associated with the segments of the second text based on word vector-based similarity between the segments; and

the associated segments of the first text are identified as the parts related to the information of the second text in the first text.

(23) The computer-readable storage medium according to (22) above wherein, in Step (a), in the process of association, at least one segment of the first text is associated with each segment of the second text.
(24) The computer-readable storage medium according to (22) above,

wherein in Step (a),

the division into segments is carried out on a sentence-by-sentence or paragraph-by-paragraph basis, and

furthermore, when the first text and the second text describe contents of a conversation between a plurality of people, the division into segments is carried out on a sentence-, paragraph-, utterance, or speaker basis.

(25) The computer-readable storage medium according to (21) above,

wherein, in Step (b),

words of predetermined types,

words whose frequency of occurrence is not lower than a preset threshold value,

words located in phrasal units that have located therein common words occurring in a common meaning in the parts identified in Step (a) and the information of the second text, to which they are related,

words whose distance from the common words is not greater than a predetermined threshold value,

words located in phrasal units whose dependency distance from the phrasal units containing the common words is not greater than a predetermined threshold value, or

words corresponding to two or more of these words are identified among the words contained in the parts identified in Step (a), and

the identified words are extracted.

(26) The computer-readable storage medium according to (21) above,

wherein in Step (b), furthermore, topic relevance scores are computed that indicate the degree to which the extracted words are related to the information of the second text and, at the same time, rise in value as the degree of relatedness increases, and

in Step (c), the statistical model is generated such that the higher the values of the corresponding topic relevance scores, the larger the extent of occurrence of the extracted words.

(27) The computer-readable storage medium according to (26) above.

wherein in Step (a), furthermore, association scores are computed that indicate the degree of content match between the identified parts and the information of the second text, to which they are related, and, at the same time, rise in value as the degree of match increases, and

in Step (b), the topic relevance scores are computed such that, for words present in parts with higher association scores, the topic relevance scores of the extracted words are made higher.

(28) The computer-readable storage medium according to (21) above,

wherein the program further comprises instructions directing the computer to execute the step of:

(d) extracting common words occurring in a common meaning from the parts identified in Step (a) and the information of the second text, and

wherein furthermore, in Step (c), furthermore, the statistical model is generated such that the extents of occurrence of the respective common words extracted in Step (d) are made larger than the extent of occurrence of words contained in the second text that are not the above-mentioned common words.

(29) The computer-readable storage medium according to (28) above,

wherein, in Step (d), furthermore, likelihood-of-use scores are computed that indicate the likelihood that the extracted common words are used in parts related to the specific topic in the first text and, at the same time, rise in value as the likelihood of use increases, and

in Step (c), the statistical model is generated such that the higher the values of the corresponding likelihood-of-use scores, the larger the extent of occurrence of the extracted common words.

(30) The computer-readable storage medium according to (29) above,

wherein in Step (a), furthermore, association scores are computed that indicate the degree of content match between the identified parts and the information of the second text, to which they are related, and, at the same time, rise in value as the degree of match increases, and

in Step (d), the likelihood-of-use scores are computed such that, for words present in parts with higher association scores, the likelihood-of-use scores of the extracted common words are made higher.

### INDUSTRIAL APPLICABILITY

The present invention can be employed when using a text under analysis and a topic-related text that depicts events identical to those of said text under analysis and describes a specific topic. The present invention is particularly effective when the topic-related text and the parts relating to the specific topic contained in the text under analysis are not identical and contain mutually different vocabulary.

For example, telephone call speech at Call Center is used to obtain speech-recognized text based on telephone call speech and Help Desk memos produced by transcribing telephone call speech. The present invention is applicable and effective when the speech-recognized text is used as text to be analyzed and text relating to the specific topic in the Help Desk memo is used as topic-related text.

In addition, the present invention is applicable and effective when, for example, the script of a news program is used as text to be analyzed, and news articles covering the specific topic among the newspaper articles from the same date as the news program are used as topic-related text.

Furthermore, the present invention is applicable and effective when speech-recognized text produced from the audio of a meeting or the text of its transcription are used as text to be analyzed, and minutes created during said meeting or text related to the specific topic that is contained in printed materials used at the meeting are used as topic-related text.

In addition, the present invention is applicable and effective when a paper is used as text to be analyzed and text relating to the specific topic in a publication of said paper is used as topic-related text.

### DESCRIPTION OF THE REFERENCE NUMERALS

10 Input device (Embodiment 1)
20 Output device (Embodiment 1)
30 Information analysis apparatus (Embodiment 1)
31 Related passage identification unit (Embodiment 1)
32 Latent topic word extraction unit (Embodiment 1)
33 Statistical model generation unit (Embodiment 1)
34 Segmentation unit (Embodiment 1)
35 Association unit (Embodiment 1)
36 Word extraction unit (Embodiment 1)
110 Input device (Embodiment 2)
120 Output device (Embodiment 2)
130 Information analysis apparatus (Embodiment 2)
131 Related passage identification unit (Embodiment 2)
132 Latent topic word extraction unit (Embodiment 2)
133 Statistical model generation unit (Embodiment 2)
134 Segmentation unit (Embodiment 2)
135 Association unit (Embodiment 2)
136 Word extraction unit (Embodiment 2)
137 Filtering unit (Embodiment 2)
210 Input device (Embodiment 3)
220 Output device (Embodiment 3)
230 Information analysis apparatus (Embodiment 3)
231 Related passage identification unit (Embodiment 3)
232 Latent topic word extraction unit (Embodiment 3)
233 Statistical model generation unit (Embodiment 3)
234 Segmentation unit (Embodiment 3)
235 Association unit (Embodiment 3)
236 Word extraction unit (Embodiment 3)
237 Common word extraction unit (Embodiment 3)
310 Computer
311 CPU
312 Main memory
313 Storage device
314 Input interface
315 Display controller
316 Data reader/writer
317 Communication interface
318 Input devices
319 Display device
320 Storage medium
321 Bus

1. An information analysis apparatus generating a topic-related statistical model of words contained in a first text to be analyzed, comprising:
a related passage identification unit that compares a second text, which describes events identical to those of the first text and contains information related to a specific topic, with the first text, and identifies the parts in the first text that are related to the information of the second text,
a latent topic word extraction unit that extracts the words contained in the parts identified by the related passage identification unit, and
a statistical model generation unit that generates a statistical model estimating the extent to which the words contained in the first text occur in the specific topic,
wherein the statistical model generation unit generates the statistical model in such a manner that the extent, to which words contained in the second text and the words extracted by the latent topic word extraction unit occur in the specific topic, is made larger than the extent of occurrence of other words.

2. The information analysis apparatus according to claim 1,
wherein the related passage identification unit divides the first text and the second text into segments respectively serving as set processing units;
compares the first text with the second text on a segment-by-segment basis and associates the segments of the first text with the segments of the second text based on word vector-based similarity between the segments; and
identifies the associated segments of the first text as the parts related to the information of the second text in the first text.

3. The information analysis apparatus according to claim 2,
wherein the related passage identification unit, in the process of the association, associates at least one segment of the first text with each segment of the second text.

4. The information analysis apparatus according to claim 2,
wherein the related passage identification unit carries out the division into segments on a sentence-by-sentence or paragraph-by-paragraph basis, and
furthermore, when the first text and the second text describe contents of a conversation between a plurality of people, carries out the division into segments on a sentence-, paragraph-, utterance, or speaker basis.

5. The information analysis apparatus according to claim 1, wherein
the latent topic word extraction unit identifies
words of predetermined types,
words whose frequency of occurrence is not lower than a preset threshold value,
words located in phrasal units that have located therein common words occurring in a common meaning in the parts identified by the related passage identification unit and the information of the second text, to which they are related,
words whose distance from the common words is not greater than a predetermined threshold value,
words located in phrasal units whose dependency distance from the phrasal units containing the common words is not greater than a predetermined threshold value, or
words corresponding to two or more of these words from the words contained in the parts identified by the related passage identification unit, and
extracts the identifies words.

6. The information analysis apparatus according to claim 1,
wherein the latent topic word extraction unit further computes topic relevance scores that indicate the degree to which the extracted words are related to the information of the second text and, at the same time, rise in value as the degree of relatedness increases, and
the statistical model generation unit generates the statistical model such that the higher the values of the corresponding topic relevance scores, the larger the extent of occurrence of the extracted words.

7. The information analysis apparatus according to claim 6,
wherein the related passage identification unit further computes association scores that indicate the degree of content match between the identified parts and the information of the second text, to which they are related, and, at the same time, rise in value as the degree of match increases, and
the latent topic word extraction unit computes the topic relevance scores such that for words present in parts with higher association scores the topic relevance scores of the extracted words are made higher.

8. The information analysis apparatus according to claim 1, further comprising a common word extraction unit that extracts common words occurring in a common meaning from the parts identified by the related passage identification unit and the information of the second text,
wherein the statistical model generation unit further generates the statistical model such that the extents of occurrence of the respective common words extracted by the common word extraction unit are made larger than the extent of occurrence of words contained in the second text that are not the common words.

9. The information analysis apparatus according to claim 8,
wherein the common word extraction unit further computes likelihood-of-use scores that indicate the likelihood that the extracted common words are used in parts related to the specific topic in the first text and, at the same time, rise in value as the likelihood of use increases, and
the statistical model generation unit generates the statistical model such that the higher the values of the corresponding likelihood-of-use scores, the larger the extent of occurrence of the extracted common words.

10. The information analysis apparatus according to claim 9,
wherein the related passage identification unit further computes association scores that indicate the degree of content match between the identified parts and the information of the second text, to which they are related, and, at the same time, rise in value as the degree of match increases, and
the common word extraction unit computes the likelihood-of-use scores such that, for words present in parts with higher association scores, the likelihood-of-use scores of the extracted common words are made higher.

11. An information analysis method used for generating a topic-related statistical model of words contained in a first text to be analyzed, the method comprising the steps of:
(a) comparing a second text, which describes events identical to those of the first text and contains information related to a specific topic, with the first text, and identifying the parts in the first text that are related to the information of the second text;
(b) extracting the words contained in the parts identified in Step (a), and
(c) generating a statistical model estimating the extent, to which words contained in the first text occur in the specific topic, and, at such time, ensuring that the extent, to which the words contained in the second text and the words extracted in Step (b) occur in the specific topic, is made larger than the extent of occurrence of other words.

12. The information analysis method according to claim 11,
wherein in Step (a),
the first text and the second text are divided into segments respectively serving as set processing units;
the first text and the second text are compared on a segment-by-segment basis and the segments of the first text are associated with the segments of the second text based on word vector-based similarity between the segments; and
the associated segments of the first text are identified as the parts related to the information of the second text in the first text.

13. The information analysis method according to claim 12,
wherein, in Step (a), in the process of association, at least one of the segments of the first text is associated with each segment of the second text.

14. The information analysis method according to claim 12,
wherein in Step (a), the division into segments is carried out on a sentence-by-sentence or paragraph-by-paragraph basis, and
furthermore, when the first text and the second text describe contents of a conversation between a plurality of people, the division into segments is carried out on a sentence-, paragraph-, utterance, or speaker basis.

15. The information analysis method according to claim 11,
wherein, in Step (b),
words of predetermined types,
words whose frequency of occurrence is not lower than a preset threshold value,
words located in phrasal units that have located therein common words occurring in a common meaning in the parts identified in Step (a) and the information of the second text, to which they are related,
words whose distance from the common words is not greater than a predetermined threshold value,
words located in phrasal units whose dependency distance from the phrasal units containing the common words is not greater than a predetermined threshold value, or
words corresponding to two or more of these words are identified among the words contained in the parts identified in Step (a), and
the identified words are extracted.

16. The information analysis method according to claim 11,
wherein in Step (b), furthermore, topic relevance scores are computed that indicate the degree to which the extracted words are related to the information of the second text and, at the same time, rise in value as the degree of relatedness increases, and
in Step (c), the statistical model is generated such that the higher the values of the corresponding topic relevance scores, the larger the extent of occurrence of the extracted words.

17. The information analysis method according to claim 16,
wherein in Step (a), furthermore, association scores are computed that indicate the degree of content match between the identified parts and the information of the second text, to which they are related, and, at the same time, rise in value as the degree of match increases, and
in Step (b), the topic relevance scores are computed such that, for words present in parts with higher association scores, the topic relevance scores of the extracted words are made higher.

18. The information analysis method according to claim 11, further comprising the step of:
(d) extracting common words occurring in a common meaning from the parts identified in Step (a) and the information of the second text,
wherein furthermore, in Step (c), the statistical model is generated such that the extents of occurrence of the respective common words extracted in Step (d) are made larger than the extent of occurrence of words contained in the second text that are not the above-mentioned common words.

19. The information analysis method according to claim 18,
wherein in Step (d), furthermore, likelihood-of-use scores are computed that indicate the likelihood that the extracted common words are used in parts related to the specific topic in the first text and, at the same time, rise in value as the likelihood of use increases, and
in Step (c), the statistical model is generated such that the higher the values of the corresponding likelihood-of-use scores, the larger the extent of occurrence of the extracted common words.

20. The information analysis method according to claim 19,
wherein in Step (a), furthermore, association scores are computed that indicate the degree of content match between the identified parts and the information of the second text, to which they are related, and, at the same time, rise in value as the degree of match increases, and
in Step (d), the likelihood-of-use scores are computed such that, for words present in parts with higher association scores, the likelihood-of-use scores of the extracted common words are made higher.

21. A computer-readable storage medium having recorded thereon a software program for generating, on a computer, a topic-related statistical model of words contained in a first text to be analyzed, the program comprising instructions directing the computer to execute the steps of:
(a) comparing a second text, which describes events identical to those of the first text and contains information related to a specific topic, with the first text, and identifying the parts in the first text that are related to the information of the second text;
(b) extracting the words contained in the parts identified in Step (a), and
(c) generating a statistical model estimating the extent to which words contained in the first text occur in the specific topic, and, at such time, ensuring that the extent, to which the words contained in the second text and the words extracted in Step (b) occur in the specific topic, is made larger than the extent of occurrence of other words.

22. The computer-readable storage medium according to claim 21,
wherein in Step (a),
the first text and the second text are divided into segments respectively serving as set processing units;
the first text and the second text are compared on a segment-by-segment basis and the segments of the first text are associated with the segments of the second text based on word vector-based similarity between the segments; and
the associated segments of the first text are identified as the parts related to the information of the second text in the first text.

23. The computer-readable storage medium according to claim 22, wherein, in Step (a), in the process of association, at least one segment of the first text is associated with each segment of the second text.

24. The computer-readable storage medium according to claim 22,
wherein in Step (a),
the division into segments is carried out on a sentence-by-sentence or paragraph-by-paragraph basis, and
furthermore, when the first text and the second text describe contents of a conversation between a plurality of people, the division into segments is carried out on a sentence-, paragraph-, utterance, or speaker basis.

25. The computer-readable storage medium according to claim 21,
wherein, in Step (b),
words of predetermined types,
words whose frequency of occurrence is not lower than a preset threshold value,
words located in phrasal units that have located therein common words occurring in a common meaning in the parts identified in Step (a) and the information of the second text, to which they are related,
words whose distance from the common words is not greater than a predetermined threshold value,
words located in phrasal units whose dependency distance from the phrasal units containing the common words is not greater than a predetermined threshold value, or
words corresponding to two or more of these words are identified among the words contained in the parts identified in Step (a), and
the identified words are extracted.

26. The computer-readable storage medium according to claim 21,
wherein in Step (b), furthermore, topic relevance scores are computed that indicate the degree to which the extracted words are related to the information of the second text and, at the same time, rise in value as the degree of relatedness increases, and
in Step (c), the statistical model is generated such that the higher the values of the corresponding topic relevance scores, the larger the extent of occurrence of the extracted words.

27. The computer-readable storage medium according to claim 26.
wherein in Step (a), furthermore, association scores are computed that indicate the degree of content match between the identified parts and the information of the second text, to which they are related, and, at the same time, rise in value as the degree of match increases, and
in Step (b), the topic relevance scores are computed such that, for words present in parts with higher association scores, the topic relevance scores of the extracted words are made higher.

28. The computer-readable storage medium according to claim 21,
wherein the program further comprises instructions directing the computer to execute the step of:
(d) extracting common words occurring in a common meaning from the parts identified in Step (a) and the information of the second text, and
wherein furthermore, in Step (c), furthermore, the statistical model is generated such that the extents of occurrence of the respective common words extracted in Step (d) are made larger than the extent of occurrence of words contained in the second text that are not the above-mentioned common words.

29. The computer-readable storage medium according to claim 28,
wherein, in Step (d), furthermore, likelihood-of-use scores are computed that indicate the likelihood that the extracted common words are used in parts related to the specific topic in the first text and, at the same time, rise in value as the likelihood of use increases, and
in Step (c), the statistical model is generated such that the higher the values of the corresponding likelihood-of-use scores, the larger the extent of occurrence of the extracted common words.

30. The computer-readable storage medium according to claim 29,
wherein in Step (a), furthermore, association scores are computed that indicate the degree of content match between the identified parts and the information of the second text, to which they are related, and, at the same time, rise in value as the degree of match increases, and
in Step (d), the likelihood-of-use scores are computed such that, for words present in parts with higher association scores, the likelihood-of-use scores of the extracted common words are made higher.
